(19) United States
(12) Patent Application Publication
(10) Pub. No.: US 2006/0083146 A1
(43) Pub. Date: Apr. 20, 2006

(54) Information reproduction apparatus

(76) Inventors: Fumio Isshiki, Yokohama (JP); Koichi Watanabe, Hachioji (JP); Kenichi Shimada, Yokohama (JP); Takahiro Kurokawa, Fujisawa (JP)

Correspondence Address: ANTONELLI, TERRY, STOUT & KRAUS, LLP, 1300 NORTH SEVENTEENTH STREET, SUITE 1800, ARLINGTON, VA, 22209-3873, US

(21) Appl. No.: 11/059,683

(22) Filed: Feb. 17, 2005

(30) Foreign Application Priority Data
Oct. 18, 2004 (JP) 2004-302367

(51) Int. Cl. G11B 7/135

(52) U.S. Cl. 369/112.03; 369/44.41; 369/112.01

(57) ABSTRACT

For optical disk apparatus compatible with multiple standards, employing multiple source beams with different wavelengths, less costly implementations of the photodetecting optics section and associated circuitry are presented. A photodetector plane dedicated to RF signal detection is provided. By bandwidth combining an RF signal detected by this plane is with another signal from other photodetector planes, S/N ratio is improved. For beam splitting, diffraction gratings are used and adjustment precision requirement is relaxed greatly. AC amplifiers can be used as RF photocurrent amplifiers.

### CLAIM OF PRIORITY

The present application claims priority from Japanese application JP 2004-302367 filed on Oct. 18, 2004, the content of which is hereby incorporated by reference into this application.

### FIELD OF THE INVENTION

The present invention relates to optical disk apparatus, optical disk media, and optical information storage devices that record or reproduce information to/from a recording medium, using light. In particular, the invention relates to information reproduction apparatus compatible with multiple schemes/standards and having high-speed and high-density recording performance, using a plurality of source beams with different wavelengths and high-density disks using blue light or blue-violet light in which, especially, readback signal quality is a challenge.

### BACKGROUND OF THE INVENTION

Optical recording media typified by optical disks are being improved to have higher information recording density and higher information reading speed. However, such higher speed and density optical disks encounter a problem of deterioration in quality of detected signals, represented by a signal/noise ratio (S/N ratio). Insufficient S/N ratio with such disks, lately developed, is mainly due to introduction of short wavelength light, typically, blue light, as light source, which reduces the size of a light spot smaller than in conventional optical devices and, consequently, increases the power density of light converging at the light spot on the recording layer of a recording medium. There is a limitation of the power density of light hitting on the recording layer by which recorded information can be read without loss of recorded data by heat or thermal decay. As a result, the absolute amount of signal light received from the smaller light spot becomes deficient.

Higher reading speed leads to shorter detection time and the total amount of light that can be detected per unit time decreases and this also causes the insufficient S/N ratio. Optical recording media typified by optical disks, classified into a number of schemes, are available on the market. Capability of optical disk reading/writing compatible with multiple standards/schemes has become a great factor influencing convenience. To accommodate such a number of recording schemes and standards, in configuring an optical disk recording/reproduction device having compatibility for diverse types of disks that can be used commonly, the section of optics for receiving light from the optical head becomes complex. The increased number of optics components poses a problem such as loss of light amount, which also causes the insufficient S/N ratio. Higher density and speed performances and the need to be compatible with multiple standards are making it hard for optical heads of recent high-density optical information recording devices to improve the S/N ratio optically.

### SUMMARY OF THE INVENTION

To solve the above problems, among methods proposed heretofore, e.g., JP-A No. 149565/1998 discloses a method for improving the S/N ratio by using photodetectors as shown in FIG. 2B instead of those shown in FIG. 2A in an instance where defocusing and detracking are detected by a three-spot method. To capture a readout signal for use in data decoding, it is needed to obtain a total amount of light hitting on a center spot detector 1a, 1b, or 1c. As shown in FIG. 2A, when a four-quadrant photodetector is used as the center spot detector 1a, a circuit is required, as is shown in FIG. 3A, in which signals from four photocurrent amplifiers 4 are added by an adder 5 and a readout signal 6 is generated. Because noise components produced by the four photocurrent amplifiers 4 are added, noise involved in the generated readout signal 6 increases by 6 dB. To improve this, by using the photodetectors shown in FIG. 2B instead of those shown in FIG. 2A, a readout signal can be detected by a single center spot detector 1b and amplified by a single photocurrent amplifier 4, as is shown in FIG. 3B, and noise involved in the generated readout signal 6 can be reduced by 6 dB as compared with the circuitry of FIG. 2A. Other detectors 2a, 2b, 2c, 3a, 3b, 3c are sub spot detectors and used to detect light for tracking and auto-focusing control purposes.

In the three-spot method, typically, a diffraction grating (which is referred to as a first diffraction grating in this application) located in front of a medium (disk) splits a beam from a center spot into sub spot beams and the sub spot beams irradiate the recording medium in different positions from the center spot. Thus, a readout signal (RF signal) cannot be captured from the sub spots. To capture the RF signal, it is needed to detect a signal of the center spot corresponding to a zero-order beam. Therefore, sub spot detectors 2a, 3a at both sides in FIG. 2A are unable to detect the RF signal and the arrangement in which the center spot detector has an entire plane dedicated to receiving the beam of the RF signal, as shown in FIG. 2B, was used. However, in this method, if, for instance, an information reproduction device for optical disks compatible with multiple standards is configured to use laser beams with two wavelengths from the laser light source, the diffraction grating 12 diffracts the incident beam at different angles depending on the wavelengths, and the sub spots on the detectors are displaced. Thus, it is needed to replace the sub spot detector 3b in FIG. 2B with one that is divided into more sub-planes, like the sub spot detector 3c shown in FIG. 2C. If laser beams with three or more wavelengths from the light source are used, the sub spot detector must be divided into even more sub-planes and, accordingly, the circuitry in the following stage must become complex, which was a factor of forcing up costs.

Given that the device is intended to support information reproduction from diverse optical disks, according to a number of standards, as regards, e.g., a ROM medium (read only recording medium), there was a problem in which tracking errors cannot be detected correctly by differential phase detection, because the four-quadrant photodetectors are present on the sub spots in the arrangement of detectors as shown in FIG. 2B.

In conventional information reproduction devices for optical disks and the like, as the photocurrent amplifier 4 shown in FIG. 3, a direct-current (DC) amplifier that can detect a change in DC for the amount of light detected, relative to a signal potential corresponding to the zero amount of light, is used in relation to subsequent signal processing circuitry. For the DC amplifier implementation, a differential amplifier, which is shown in FIG. 4A, is often used to correctly amplify a DC component of zero reference. The differential amplifier is, in principle, a circuit that is configured with a pair of transistor elements 80 and is able to output an amplified voltage in proportion to a difference between two input signals. However, because its operation is the same as that two amplifiers add two signals with opposite phases, the signal noise increases by 6 dB as compared with an alternating-current (AC) amplifier which is shown in FIG. 4B and the use of the differential amplifier was one factor of deteriorating signal quality. With recent optical disk technology achieving higher speed and higher density, as the margin of S/N ratio becomes narrower, noise produced in the circuit of this differential amplifier configuration has been considered to be a problem.

Then, the present invention aims to solve the signal noise problem induced by compatibility with multiple schemes and higher density and speed performances of optical information reproduction devices, typified by optical disk devices, and provide a more convenient, optical information reproduction apparatus. The compatibility with multiple schemes means that reproduction of data from optical disks compliant to different standards for multiple wavelengths/schemes using, e.g., infrared light, red light, and blue light, is performed with a same optical head. The problem of cost increase due to complication of the optics section to support the compatibility with multiple schemes should be challenged.

The signal noise problem induced by higher density is, in particular, attributed to the reduced diameter of a light spot when the applied beam is switched from red light to blue light. As the light spot becomes smaller, the absolute amount of light for reproduction becomes insufficient (signal light (S) decreases) and the S/N ratio decreases. The signal noise problem induced by higher speed is, in particular, attributed to the extended bandwidth of detection with higher speed, which consequently increases noise (N) detected and decreases the S/N ratio.

The present invention addresses the realization of the above aims at low costs by elaborating the configuration of the optics section and circuits of the optical head and optical disk apparatus. Although a detector dedicated to RF signal detection (RF detector) is described in JP-A No. 149565/1998 and JP-A No. 039702/1999, these documents do not state that the RF detector receives a first-order beam and noise is compensated by DC variation or the like. JP-A No. 011773/1998 states that the RF detector is used to receive a first-order beam, but does not discuss AF detection of the zero-order beam (this document discusses AF detection of the first-order beam). In JP-A No. 167442/2001, a technique for eliminating crosstalk by arithmetic processing of a main track signal and a focus error signal is disclosed. However, this document does not state that the RF detector receives the first-order beam and noise is compensated by DC variation or the like. Although RF detection of the first-order beam is disclosed in JP-A No. 232321/1993 and JP-A No. 351255/2001, these documents do not reveal that a detector is dedicated to receiving such light. JP-A No. 308309/1994 states that the RF detector receives the first-order beam diffracted by hologram, but does not discuss AF detection of the zero-order beam. JP-A No. 306579/1999 discusses polarization and splitting using a Wollaston prism for magneto-optical recording, but does not state that the RF detector receives the first-order beam diffracted by a diffraction grating.

To improve readout signal quality (S/N ratio) in optical information reproduction apparatus with enhanced density and speed and compatible with multiple standards, by elaborating the optics section and associated circuitry including a photoelectric converter up to a decoder, the present invention enables signal and information reproduction with improved S/N ratio and enhanced compatibility with multiple schemes.

In the present invention, another diffraction grating (which is referred to as a second diffraction grating herein) is located between the medium and the signal detection section. An RF signal as a first-order beam diffracted by this second diffraction grating is detected by a detector plane dedicated to RF signal detection. Zero-order beams transmitted through the second diffraction grating are used for AF control and TR control. A first diffraction grating that is used for the three-spot method is located between the light source and the information recording medium. The second diffraction grating that performs beam splitting to direct beams to the detector plane dedicated to RF signal detection is located between the information recording medium and the signal detection section. Zero-order beams which are used for AF control and TR control are those transmitted through both the first and second diffraction gratings. Thereby, compatibility with multiple standards and schemes is improved. Since RF signals as first-order beams are detected by the detector plane dedicated to RF signal detection, even if the spot is displaced upon change of source beam wavelength, the RF signals can be detected by the same detector plane and RF detection by a single detector plane decrease noise. By using zero-order beams for AF control and TR control, the spot is not displaced even if source beam wavelength is changed. By this configuration, even for the apparatus employing multiple source beams with different wavelengths, cost reduction and noise cut are feasible by using the same AF detector planes and compatibility with multiple standards and schemes is enhanced.

For circuitry to amplify the signals obtained as above, for example, a frequency bandwidth combining circuit may be configured to combine a first RF signal and a second RF signal. The first RF signal is detected by the detector plane dedicated to RF signal detection and the second RF signal is detected by other detector planes for AF control and TR control. In particular, an adder is provided to add a differential signal obtained by subtracting the first RF signal passed through one low-pass filter from the second RF signal passed through another low-pass filter to the first RF signal and output a combined RF signal. For a low frequency portion of the RF signal passing through the filter, by addition and subtraction of the corresponding part of the first RF signal, the first signal is canceled and the second RF signal is output. For a high frequency portion of the RF signal, the high frequency component of the first RF signal is output as is. Thereby, a frequency domain with low frequency sensitivity of one signal is compensated by the corresponding domain of the other signal. Signals having better noise characteristics in a frequency bandwidth can be merged into a combined signal with low noise. In another example of the bandwidth combining circuit, a low-pass filter is located at a later stage and a differential signal between the first RF signal (detected by the single RF detector plane) and the second RF signal (detected by other detector planes for AF/TR control) is let pass through the low-pass filter. An adder is provided to add the differential signal after filtered to the first RF signal and output a combined RF signal. As is the case for the foregoing bandwidth combining circuit, the second RF signal is output for the low frequency domain passing through the filter and the first RF signal is output for the high frequency domain. By such bandwidth combing in which a frequency domain with low frequency sensitivity of one signal is compensated by the corresponding domain of the other signal, a low noise RF signal can be obtained.

For another method of processing signals detected by the above detector planes, in an arrangement, the first RF signal (detected by the single RF detector plane) and the second RF signal (detected by other detector planes for AF/TR control) are separately used. In this case, based on clipping, variation in the DC level of the first RF signal is detected and corrected and the DC level offset voltage is added to the first RF signal before the signal is output to the decoder. The DC level is adjusted and incremented, if necessary, so that the signal falls within the clipping range, and the signal is thus corrected. Thereby, unstable amplified signals in which the DC level may vary can be corrected to be decoded properly.

Definitions of Terms

In this application, a readout signal for data decoding in proportion to the amount of light reflected from a light spot is referred to as an RF signal having a radio-frequency component for decoding. This is a signal corresponding to the amount of reflected light which is used for decoding a recorded signal. In general, the RF signal has the RF signal component for decoding in a frequency range above 10 kHz. Control for auto-focusing is referred to as AF control and a signal for detecting a defocusing amount is referred to as an AF signal. Control for tracking follow-up and adjustment of tracks on which information is recorded is referred to as TR control and a signal for detecting a detracking amount is referred to as a TR signal.

A detector plane of a photodetector for detecting an RF signal is referred to as an RF signal detector plane and a set of such detector planes is referred to as an RF signal detection unit. A detector plane of a photodetector for detecting a TR signal is referred to as a TR signal detector plane and a set of such detector planes is referred to as a TR signal detection unit. An amplifier in which the amplifier gain for direct-current (0 Hz) drops less than a half of alternating-current gain is referred to as an alternating-current (AC) amplifier. An amplifier in which the amplifier gain for direct-current is as much as alternating-current gain is referred to as a direct-current (DC) amplifier.

On beam irradiation on an information recording medium, a beam reflected back from the medium is referred to as a reflected beam. A beam transmitted without being diffracted by a diffraction grating is referred to as a zero-order beam. A beam diffracted in a first order of diffraction of the grating is referred to as a first-order beam. An entity that is not completely perpendicular to a given line or object, but is angled within on the order of 15 degrees off the perpendicularity, and that can be regarded as being perpendicular substantially, is described as the entity that is substantially perpendicular to the given line or object. Attenuating the amplitude of a signal above or below a given frequency band is referred to as cut-off.

The RF signal mentioned herein is a signal in proportion to the whole amount of light of the reflected beam. A signal within a partial frequency range extracted from the above signal in proportion to the whole amount of light is also referred to as an RF signal. The RF signal detection unit includes a photodetector having subdivision detector planes, like a four-quadrant photodetector. Such photodetector is able to detect an RF signal by adding signals detected by the subdivision detector planes. In this application, not only an apparatus that carries out optical information reproduction, but also such apparatus including an optical pickup assembly equivalent of an optical head is referred to as an optical information reproduction apparatus.

For optical information reproduction devices compatible with multiple wavelengths and multiple standards, employing multiple source beams with different wavelengths, the present invention can enhance compatibility, data rate, and reliability by elaborating the optics section and associated circuits.

### BRIEF DESCRIPTION OF THE DRAWINGS

FIG. 1 shows an example of arrangement comprising a photodetecting optics section, detected light signal amplifiers, and related circuitry, according to the present invention;

FIG. 2A shows an example of conventional arrangement of an optics section;

FIG. 2B shows another example of conventional arrangement of an optics section;

FIG. 2C shows a further example of conventional arrangement of an optics section;

FIG. 3A shows a signal path circuit for the conventional optics section, regarded as a factor leading to S/N ratio deterioration;

FIG. 3B shows an improved signal path for the conventional optics section;

FIG. 4A shows an example of a first-stage DC amplifier configuration;

FIG. 4B shows an example of a first-stage AC amplifier configuration;

FIG. 5 shows a configuration example of an optics section and a first-stage amplifier circuit according to the present invention;

FIG. 6 shows a circuit configuration example of an AC amplifier employing compound semiconductor transistors;

FIG. 7A shows an example of bandwidth gain characteristics of an AC amplifier;

FIG. 7B shows an example of bandwidth gain characteristics of a DC amplifier;

FIG. 8A shows a noise spectrum example for an AC amplifier configured with compound semiconductor transistors;

FIG. 8B shows a noise spectrum example for a DC amplifier configured with silicon transistors;

FIGS. 9A through 9C show graphs for explaining a principle of noise reduction by combining RF signals according to the present invention, wherein FIG. 9A for AC amplifier output, FIG. 9B for DC amplifier output, and FIG. 9C for combined RF signal;

FIG. 10 shows an example of RF signal combining circuitry according to the present invention;

FIG. 11 shows another example of RF signal combining circuitry according to the present invention;

FIG. 12 shows yet another example of RF signal combining circuitry according to the present invention;

FIG. 13 shows still another example of RF signal combining circuitry according to the present invention;

FIGS. 14A and 14B show configuration examples of a photodetecting optics section that can be employed in the present invention;

FIGS. 14A1 and 14B1 show diffraction grating examples for an embodiment of the invention;

FIGS. 14A2 and 14B2 show the top views of the optics section configuration examples of FIGS. 14A and 14B, respectively.

FIG. 15 shows a further example of RF signal combining circuitry in which gain is changed or adjusted, according to the present invention;

FIG. 16 shows a still further example of RF signal combining circuitry in which gain is changed or adjusted, according to the present invention;

FIG. 17 shows a still further example of RF signal combining circuitry provided with automatic gain adjustment according to the present invention;

FIG. 18 shows a procedure for controlling automatic gain adjustment, according to the present invention;

FIG. 19 shows a still further example of RF signal combining circuitry provided with automatic gain adjustment according to the present invention;

FIG. 20 shows a configuration example of the optical information reproduction apparatus according to the present invention;

FIG. 21A shows an example of a polarization grating;

FIG. 21B shows an example of arrangement of the photodetecting optics section according to the present invention;

FIG. 22 shows an example of an optical information reproduction apparatus configuration according to the present invention;

FIGS. 23A and 23B show signal transition graphs regarding a clipping follow-up correction method according to the present invention;

FIG. 24 shows an example of clipping follow-up correction circuitry according to the present invention;

FIG. 25 shows an example of an optical information reproduction apparatus configuration provided with clipping follow-up correction circuitry according to the present invention;

FIG. 26 shows a graph to explain the effect of speeding up according to the present invention;

FIG. 27 shown an example of DC amplifier circuitry configured with compound semiconductor transistors; and

FIG. 28 shown another example of DC amplifier circuitry with reduced noise, configured with silicon transistors.

### DETAILED DESCRIPTION OF THE PREFERRED EMBODIMENTS

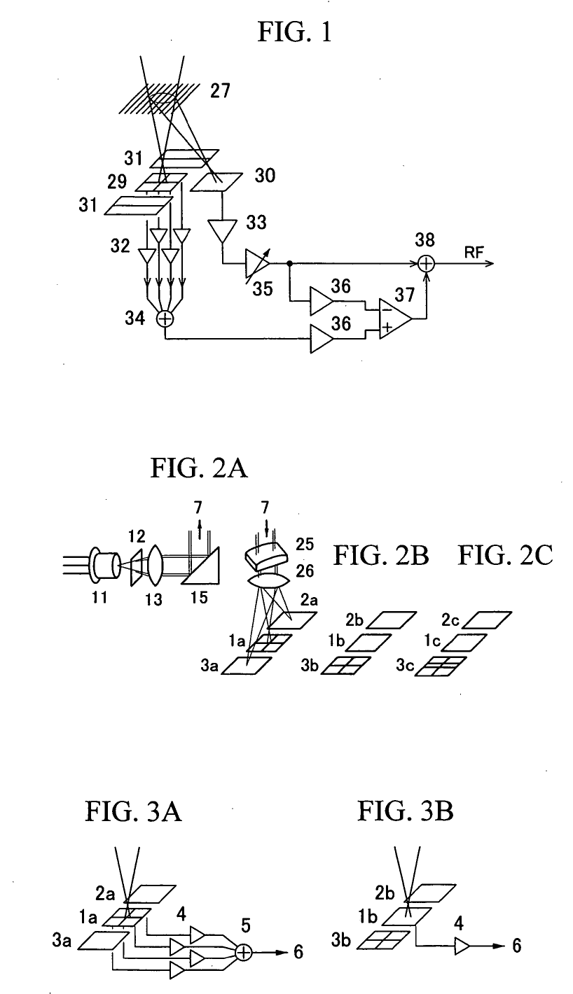

Embodiments of the present invention will be described hereinafter, using FIGS. 1 through 26. To help easy understanding, same reference numerals are assigned to similar working components in the drawings.

### First Embodiment

(Optics Section Having a Separately-Located Radio-Frequency (RF) Signal Detector Plane)

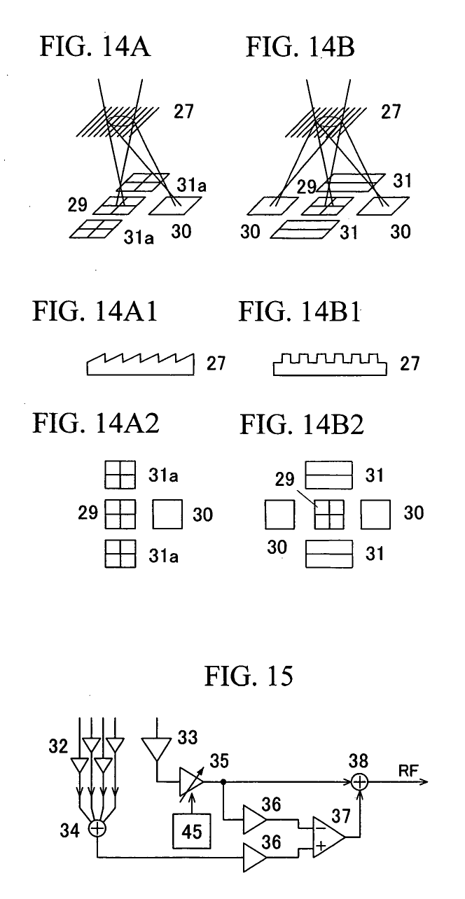

A configuration example of an optical information reproduction apparatus equipped with a detector plane dedicated to RF signal detection, according to the present invention, is discussed, using FIGS. 1 through 20. First, a configuration example of a light receiving optics section of the information reproduction apparatus, according to the present invention, is presented, using FIGS. 5 and 14.

FIG. 5 shows an example of arrangement of photodetectors having detector planes and a photocurrent amplifier connected close to the main elements, according to a differential push-pull method, which is one three-spot method. A beam from a laser light source hits an information recording medium, the light amount of the beam is modulated by information recorded there, and the beam is reflected by the medium. The reflected beam, after converged through a detection lens, enters the present optics section. Among three spots, the beams of sub spots at both sides are detected by each sub-spot detector plane 31. Meanwhile, the beam of the remaining center spot is split by a diffraction grating 27 located in front of the photodetectors into beam components, some of which directly hits a center four-quadrant photodetector 29, and some of which is directed to hit an RF signal detector plane 30. A zero-order beam transmitted through the diffraction grating 27 hits the four-quadrant photodetector 29. A first-order beam diffracted by the diffraction grating 27 hits the RF signal detector plane 30. The RF signal detector plane 30 is located in a direction substantially perpendicular to the sub-spot detector planes 31 with the four-quadrant photodetector 29 placed in the center. By placing the RF signal detector plane nearly perpendicular to the sub-spot detector planes, the diffraction angle of the diffraction grating 27 (second diffraction grating) can be made smaller. Even if laser beams with different wavelengths are applied, a shift of the position where the first-order diffracted beam is focused can be restricted within a smaller range, the photodetector area required is smaller, and the frequency characteristic can be enhanced.

While the RF signal detector plane is placed substantially perpendicular to the sub-spot detector planes on account of the above merit in this embodiment, it is not always necessary to place it in this way. The photocurrents of the beams detected by each plane of the four-quadrant photodetector 29 are amplified and output by DC photocurrent amplifiers 32 and used for generating AF and TR signals. The photocurrent of the beam detected by the RF detector is detected and output by an RF signal photocurrent amplifier 33. The TR signal is generated by the differential push-pull method from difference between the light amounts of the beams detected by the subdivision planes of the four-quadrant photodetector 29 and the sub-spot detector planes 31. A pattern of subdivision detector planes on the photodetectors in conformity with a differential astigmatic method, as is shown in FIG. 14A, may be employed. FIG. 14A2 shows a top view of the detector planes of the photodetectors of FIG. 14A.

The present optics section includes the RF signal detector (RF signal detector plane 30) which exclusively detects RF signals and the AF signal detector (four-quadrant photodetector 29). Since a recorded data signal (another RF signal) can be obtained by the sum of signals detected by the four planes of the four-quadrant photodetector, the AF signal detector can also serve as a second RF signal detector. From the sum of signals detected by two planes of the four-quadrant photodetector and the sum of signals detected by the remaining two planes thereof, a detracking amount can be detected (push-pull method). In addition, in the present configuration, there are two sub-spot detector planes 31 (first and second detectors for detecting the detracking amount). By combination of signals detected by these planes, TR detection and AF detection by the differential push-pull method and differential astigmatic method can be carried out. In this section comprised of the photodetectors, the AF signal detector and the first and second detectors for detecting the detracking amount are aligned in line and the RF signal detector is located in a direction perpendicular to that line. By employing at least three four-quadrant photodetectors as the AF signal detector and the first and second detectors for detecting the detracking amount, stable AF detection by the differential astigmatic method can be achieved and highly reliable servo control can be performed.

In the present optics section, because a readout signal of the center spot beam is split by the diffraction grating, the four-quadrant photodetectors and the RF signal detector plane can be placed, using photodetector planes on the same chip. If a semi-reflecting mirror or semi-reflecting prism is used instead of the diffraction grating, it is needed to ensure a given angle or more of reflection to provide stable performance. In this case, when the RF signal detector plane is placed on the same chip, adjusting the angle and position of the prism is needed and, consequently, costs rise. By using the diffraction grating as in the present configuration, beam splitting can be performed with the less costly diffraction grating, the RF signal detector plane can be placed by employing one of the photodetector planes of the same shape, the entire optics section can be made more compact at lower cost. Even if a converged beam is used, the non-diffracted beam transmitted through the diffraction grating and the diffracted beam are focused on the photodetector planes at virtually the same time and, thus, adjustment is easy and less costly, and high reliability is achieved. The diffraction grating may be formed in an incident beam window for the photodetectors.

In this relation, if an ordinary diffraction grating which is shown in FIG. 14B1 is employed as the diffraction grating 27, plus and minus first-order beams are diffracted to go toward both sides of the four-quadrant photodetector 29, as is shown in FIG. 14B. In this case, two RF signal detector planes 30 have to be placed at both sides of the four-quadrant photodetector. Instead, if a blaze-type diffraction grating having triangular grooves (in the shape of the grooves of the grating), which is shown in FIG. 14A1, beam diffraction can be controlled so that the diffracted beam goes to one side only. Thus, the blaze-type diffraction grating has the following advantages: only a single RF signal detector plane 30 is necessary; the required RF detector plane area in totality can be reduced; and photodetection with lower noise can be performed at a higher speed. Besides the braze type having triangular grooves, the use of a semi-blaze type having staircase grooves approximating the triangular grooves produces the same effect. Hereinafter, the blaze type, when mentioned, will refer to the semi-blaze type as well.

By applying the present configuration, an RF signal can be captured by the detector plane dedicated to RF signal detection and, thus, a low noise RF signal can be obtained without the need for generating an RF signal by adding four signals amplified by the DC photocurrent amplifiers. In particular, even when a DC amplifier, same as the DC photocurrent amplifiers 32, is used as an RF signal photocurrent amplifier 33, the noise of the amplifier output signal can be reduced by 6 dB as compared with the output signal obtained by amplifying and adding the signals detected by the four-quadrant photodetector planes. Meanwhile, if the amount of light is evenly divided into two parts of 50% by the diffraction grating in this configuration, the amount of light of the RF signal is cut by half and decreases by 3 dB. In total, the S/N ratio is improved to 6 dB−3 dB=3 dB.

In the application of the present optics section, even when an AC amplifier is used as the RF signal photocurrent amplifier, auto-focusing and tracking can be controlled by the signals detected by the four-quadrant photodetector planes provided separately. Thus, the AC amplifier with less noise can be used instead of the DC amplifier. Because the use of the AC amplifier dispenses with a differential amplifier, noise can be reduced by 6 dB. The AC amplifier can make a further 6 dB improvement for noise in addition to the foregoing S/N ratio improvement of 3 dB; in total, the S/N ratio can be improved to 3 dB+6 dB=9 dB.

Particularly for optical disks using a blue light source, conventionally, the noise problem has been dealt with severely, because of an intrinsically small amount of light. From a perspective that ensuring as a large mount of light as possible is essential to improve the S/N ratio, it was believed that splitting the reflected beam by the diffraction grating should be avoided whenever possible and a common photodetector be used. However, in the present situation where noise produced by photocurrent amplifiers is found to be a major source of S/N ratio deterioration, by the above method in which the reflected beam is positively split into beam components which are then detected by separate photodetectors, the S/N ratio of the output signal of the photocurrent amplifier can be improved well over the reduction in the amount of light. Especially for the information reproduction apparatus for optical disks using the blue light source, in which the energy density of light of a readout signal is limited because of the material of the recording layer of the recording medium, a better S/N ratio can be obtained by provision of the detector plane dedicated to RF signal detection, as in the present invention. However, this problem was not taken serious for conventional optical disks using a red light source. The problem is specific to blue light disks, as it was presented significantly with optical disks using the blue light source. The above configuration of the present invention is especially advantageous for blue light disks. In this configuration, by combination of the optics section and its related circuit, noise generation is minimized and light signals are amplified.

In the application of the AC amplifier, the amplifier can be configured with transistors made of compound semiconducting materials (such as GaAs) of a less noise property. Thus, noise generated by the AC amplifier can be further reduced and a total S/N ratio can be more improved. This aspect will be discussed in a “Second Embodiment” section. If the ordinary diffraction grating is used instead of the blaze-type one, the diffracted beams go toward both sides of the center photodetector and, therefore, the photodetectors need to be arranged, as is shown in FIG. 14B2. In this case, two RF signal detector planes 30 are needed and the total area of the detector planes increase, and, consequently, the frequency characteristic somewhat deteriorates. However, by wiring the two RF detector planes, RF signal amplification can be performed by a single RF signal photocurrent amplifier and the same effect of improvement for noise generated by the amplifier as described above can be obtained.

In the present optics configuration, zero-order beam components not affected by diffraction of the diffraction grating are detected by the four-quadrant photodetector planes. Thus, TR signals can be generated by any of the differential push-pull method, differential phase detection, and normal push-pull method. Since AF and TR signals are generated by detecting the zero-order beam components not diffracted by the diffraction grating, spot displacement does not occur even if the applied beam wavelength from the light source changes. An advantage of this configuration is low cost, owing to compact assembly of photodetectors in constructing an optical disk apparatus compatible with multiple standards, using a plurality of source beams with different wavelengths.

The RF signal detector plane 30 has an advantage that it can continue to serve as the same detector plane even if the spot is displaced when the wavelength of the source beam changes. This advantage is particularly significant for an optical disk apparatus compatible with three wavelengths, using three or more source beams with different wavelengths and in combination with the differential astigmatic method. For use in combination with the differential astigmatic method, the photodetectors may be arranged, as shown in FIG. 14A2. In the differential astigmatic method, three four-quadrant photodetectors, each having quadrant subdivision planes, are used concurrently and a total of 12 detector planes or more are employed. If first-order beam components diffracted by the diffraction grating 27 are detected for AF and TR signal generation, spot displacement depending on the applied source beam wavelength occurs. For the spots displaced by different wavelength of each source beam, additional four-quadrant photodetector planes need to be prepared. A great number of detector planes are required and costs are increased. As illustrated in the present optics section configuration, by applying the arrangement of the AF and TR detector planes, based on the zero-order beam spot position, the same detector planes can be continued to be used even when the source beam wavelength changes. Because the number of detector planes can be reduced, this configuration has low cost and low noise merits and provides an advantage that signal detection can be performed at a higher speed.

As the photodetectors, not only photo diodes, but also an optoelectronic integrated circuit (OEIC) comprising the photo diodes and the photocurrent amplifier may be used. The use of the OEIC can prevent jitter noise along wiring and allows for more reduction of noise.

### Second Embodiment

(RF Signal Amplification with the AC Amplifier)

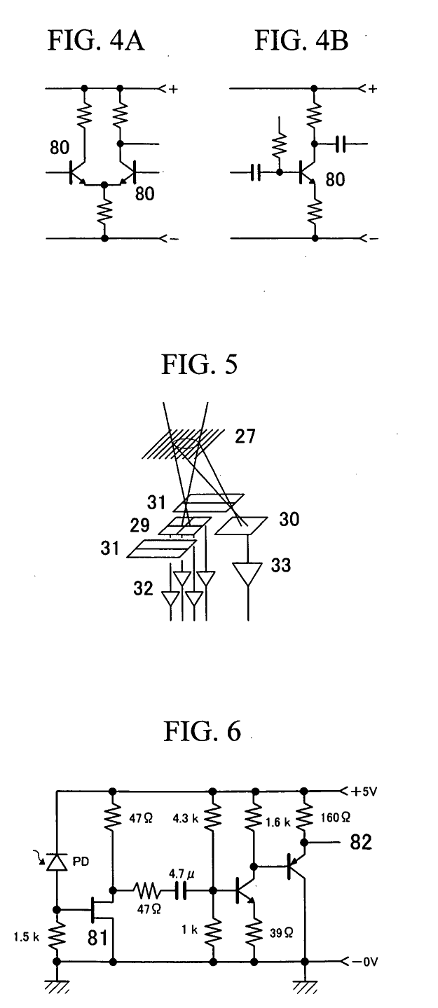

A configuration of the AC amplifier employed as the photocurrent amplifier according to the present invention and its effect are discussed, using FIGS. 4 through 8. As described above in the “Background” section, a differential amplifier shown in FIG. 4A is generally used as a DC amplifier to correctly amplify a change in DC for the amount of light detected, relative to a signal potential corresponding to the zero amount of light. In circumstances where amplifier noise must be constrained, the S/N ratio has been deteriorated by about 6 dB by this differential amplification.

By contrast, if the AC amplifier shown in FIG. 4B can be used, noise generated by the amplifier can be suppressed to a minimum level. The amplifier noise can be improved by above 6 dB as compared with the DC amplifier shown in FIG. 4A. Because of AC coupling, the AC amplifier cannot amplify a change in DC voltage. However, the AC amplifier does not have to include voltage conversion and level shift circuits and has superior noise characteristics.

The AC amplifier circuit can be constructed with compound semiconductor transistors instead of ordinary silicon semiconductor transistors (bipolar transistors). A typical compound semiconductor transistor is a metal-semiconductor field-effect transistor (MES-FET) employing GaAs. A concrete example of the photocurrent amplifier circuit formed with compound semiconductor transistors is shown in FIG. 6. As compared with a silicon semiconductor transistor, a compound semiconductor transistor has the following features: it allows for amplification to a higher frequency signal; and noise when current flows across it is one digit smaller than noise generated by a silicon semiconductor transistor. The AC amplifier with less noise can be configured with the compound semiconductor transistors and further reduction on the order of, typically, 15 dB to 20 dB in the amplifier noise can be achieved.

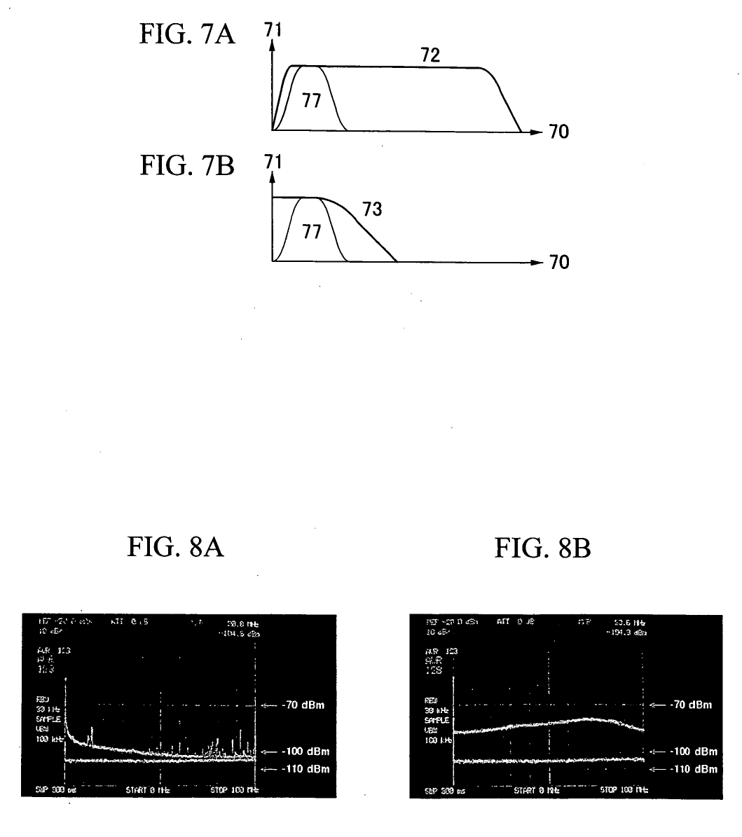

Examples of gain frequency characteristics curves of the AC amplifier and DC amplifier are shown in FIG. 7 with frequency 70 on the abscissa and signal intensity 71 on the ordinate. FIG. 7A shows a typical example of frequency characteristics of the AC amplifier gain 72, and FIG. 7B shows a typical example of frequency characteristics of the DC amplifier gain 73. For the AC amplifier, high gain up to a high frequency can be obtained, though no gain at 0 Hz (FIG. 7A). By contrast, for the DC amplifier, constant gain down to 0 Hz is obtained, but gain generally drops at higher frequencies (FIG. 7B).

As above, by employing an AC photocurrent amplifier instead of a conventional DC photocurrent amplifier, the S/N ratio can be improved by 6 dB and, by configuring the AC amplifier with compound semiconductor transistors, the S/N ratio can be improved by nearly 15 dB. Actual measurements of noise characteristics for AC and DC photocurrent amplifiers are shown in FIG. 8.

FIG. 8A shows the noise spectrum of an AC photocurrent amplifier (the level of amplification converted to resistance R=200 kΩ) configured with compound semiconductor transistors (MES-FETs). Meanwhile, FIG. 8B shows the noise spectrum of a conventional DC photocurrent amplifier (the level of amplification converted to resistance R=80 kΩ). The abscissa denotes frequency in a range of 0 to 100 MHz (10 MHz/div). The ordinate denotes noise intensity of the amplifier in a range of −120 to −20 dBm. A line shown at −105 dBm denotes a measurement limit of this measurement device. For the AC photocurrent amplifier configured with compound semiconductor transistors, it is seen that noise is generally 10 to 20 dB lower than the noise of the DC amplifier, in spite that its sensitivity (amplification factor) is higher by a factor of two or more. However, because compound semiconductor FETs have 1/f noise, the AC amplifier noise is rather higher than the DC amplifier noise in a low frequency domain (under 3 MHz).

Relatively large noise generated by compound semiconductors (GaAs-FETs in this example) in the vicinity of DC is attributed to bistability in the velocity of carries in the semiconductor, appearing in a Gunn effect. If this noise in the low frequency domain can be compensated by collaborating the circuit design or the like, there can be room for providing a readout signal with even lower noise as a whole. Because carriers move at a high velocity in the GaAs semiconductor, the transistor response speed is high and the amplifier with high gain even in a higher frequency domain can be configured with such semiconductor transistors, as compared with silicon semiconductor transistors. Therefore, the photocurrent amplifier configured with compound semiconductor transistors has better noise and frequency characteristics, as above, when it is used as the AC amplifier, though DC amplification is somewhat unstable.

Since a decoder of a conventional optical disk apparatus uses a signal potential at a DC level to detect a sync signal or the like, in some cases, correct synchronization and decoding cannot be performed on AC amplifier output signals only. Thus, signal loss in the vicinity of 0 Hz in the AC amplifier is compensated by using a DC amplifier output signal and thereby a signal (combined RF signal) substituting for an output signal of conventional DC amplifiers can be generated. This aspect will be discussed in the sections of third, fourth, fifth, and six embodiments. Alternatively, a sync signal may be detected separately, using DC amplifier output signals; in this case, only AC amplifier output signals with low noise can be decoded. This aspect will be discussed in the sections of seventh and eighth embodiments.

In addition to the elaborated optics section equipped with the detector dedicated to RF signal detector the optics section, by thus employing the AC photocurrent amplifier to amplify RF signals detected by the detector, the S/N ratio of the obtained readout signal can be more improved, as compared when the DC amplifier is used. Compound semiconductor transistors deselected for amplifier application because of unstable characteristics as DC amplifier components can be employed to configure the AC amplifier. The thus configured AC amplifier can output readout signals with even lower noise than an AC amplifier configured with ordinary transistors.

### Third Embodiment

(First Arrangement for Generating Combined RF Readout Signals)

Next, a first arrangement example for generating combined RF signals with lower noise from RF signals amplified by the AC amplifier and signals amplified through DC amplifiers from the four-quadrant photodetector planes according to the present invention and its effect are discussed, using FIG. 1 and FIGS. 8 through 16.

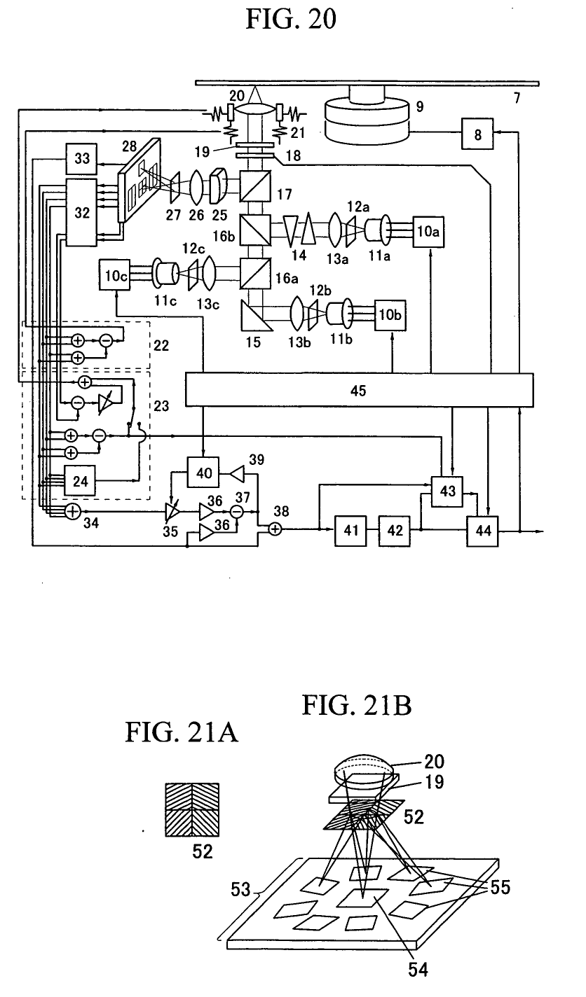

FIG. 1 shows an optical head's photodetecting section and circuitry in the vicinity of the photodetecting section (optical head) in the optical information reproduction apparatus. A diffraction grating located in front of the photodetector chip splits an incident beam to the photodetectors into two or more beam components. The arrangement of FIG. 1 is designed to detect TR and AF signals by the three-spot method. The entire structure of the apparatus will be described later, using FIG. 20.

Among three spot beams directed to hit the photodetectors, a center spot beam is split by the diffraction grating 27 into a zero-order beam which is detected by the four-quadrant photodetector 29 and a first-order diffracted beam (first-order beam) which is detected by the RF signal detector plane 30. As the diffraction grating, for example, a blaze-type grating is used. Two sub-spot beams at both sides, which are not shown in FIG. 1, are detected by sub-spot detector planes 31 and used for TR signal detection by the differential push-pull (DPP) method. Current for the light signal detected by the RF signal detector plane 30 is amplified by the RF signal photocurrent amplifier 33 and a first RF signal is output. Currents for the light signals detected by each plane of the four-quadrant photodetector 29 are amplified by four DC photocurrent amplifiers 32, respectively. The thus amplified signals are used for AF signal and TR signal generation and added by an adder 34 into a second RF signal representing a correctly amplified DC component for the light signal. The second RF signal is supplied to a first low-pass filter 36. After the first RF signal passes through a gain adjuster 35 in which the amplitude of the first RF signal in a low frequency domain is adjusted to be the same level of the second R-F signal, the first RF signal is supplied to another low-pass filter 36. A differential signal between the two RF signals passed through the low-pass filters is output by a subtractor 37. The differential signal and the first RF signal before filtered are added into a combined RF signal.

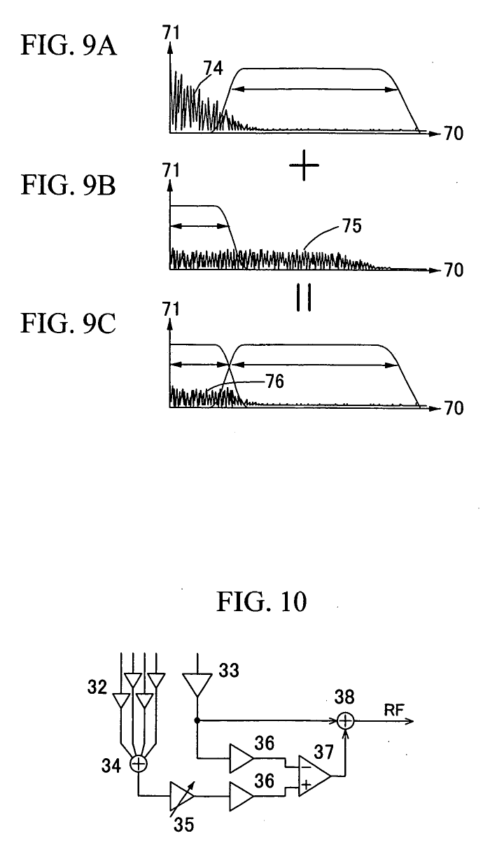

In this configuration, as the RF signal photocurrent amplifier 33, an AC amplifier is employed instead of an ordinary DC amplifier. Even if the DC level of the RF signal is lost by AC amplification, the lost DC level signal can be compensated by a DC signal generated through the DC amplifiers (DC photocurrent amplifiers) from the four-quadrant photodetector planes 29. This principle is then explained, using FIG. 9.

FIGS. 9A, 9B, and 9C show three graphs which correspond to AC amplifier noise intensity, DC amplifier noise intensity, and combined signal noise intensity, with frequency 70 on the abscissa and signal intensity 71 on the ordinate, wherein the ordinate particularly denotes noise intensity also. Although the AC amplifier noise intensity 74 is great in the low frequency domain, the advantage of the AC amplifier is lower noise in the high frequency domain than the DC amplifier noise (FIG. 9A). The DC amplifier noise intensity 73 is almost constant over the range from low to high frequencies and its advantage is relatively low noise in the low frequency domain. Then, by combining the AC amplifier output signal in the high frequency domain and the DC amplifier output signal in the low frequency domain into a signal, an RF signal with lower noise over all the frequency range can be obtained.

Then, by way of the arrangement of FIG. 1, the RF signal output by the AC amplifier (namely, RF signal photocurrent amplifier 33) and the RF signal, the sum of the signals output by the DC amplifiers (namely, DC photocurrent amplifiers 32) are filtered through each low-pass filter 36. Difference between the thus extracted low frequency domains of both RF signals is output from the subtractor 37. By adding this difference as the lost DC level signal to the RF signal output from the AC amplifier, the combined RF signal with lower noise is generated.

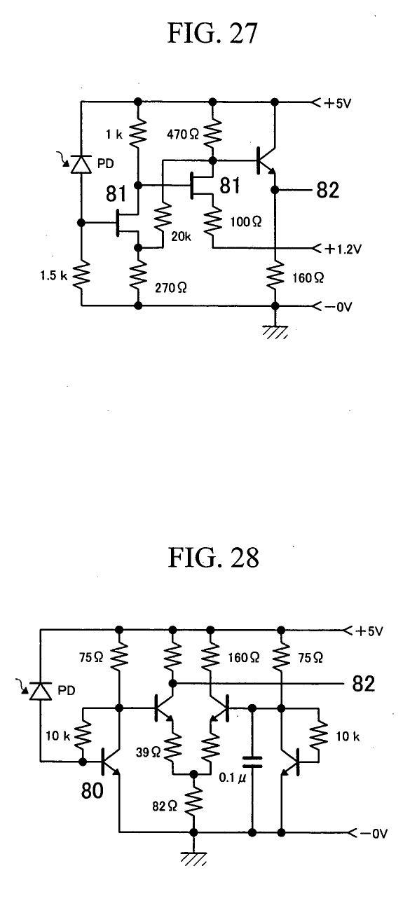

Not only the AC amplifier, a DC amplifier can also be configured with compound semiconductor transistors, as is shown in FIG. 27, for use instead of the AC amplifier. Because of the use of the compound semiconductor transistors, 1/f fluctuation of the transistors causes jitters as noise in the DC level at frequencies in the vicinity of DC. By using the above RF signal combining circuitry as shown in FIG. 1, the noise can be cut as is the case for the AC amplifier and the DC loss can be compensated by the second RF signal. In comparison with the AC amplifier, this DC amplifier configuration dispenses with a capacitor with a large capacity and may be suitable for circuit integration, when cost reduction by circuit integration is intended.

A DC amplifier with reduced noise may also be configured with silicon transistors, in which the noise reduction effect is rather less, as is shown in FIG. 28, and can be employed instead of the AC amplifier in the same way as above. In the DC amplifier configuration as shown in FIG. 28, a DC level offset is liable to occur due to variation in the performances of individual transistors and components, as compared with a similar configuration employing a differential amplifier in the first stage of amplification. Even if such offset occurs, by using the above arrangement of FIG. 1, a required bandwidth can be compensated by the second RF signal, while the DC level offset is eliminated in a similar manner. This DC amplifier configuration can be integrated into the circuitry of the DC amplifiers for the second RF signal, using a same process and, thus, is suitable for less costly circuit integration and optoelectronic integrated circuit (OEIC) implementation. Specifically, this arrangement includes the optics section for optically detecting a recorded signal on an information recording medium, the optics section primarily comprising a first signal detection unit (RF signal detector plane 30) and a second signal detection unit (four-quadrant photodetector planes 29). As shown in FIG. 1 and FIG. 10, this arrangement further includes circuitry comprising a first frequency filter (first low-pass filter 36) which cuts off a high-frequency component of the signal detected by the first signal detection unit, a second frequency filter which cuts off a high-frequency component of the signal detected by the second signal detection unit (second low-pass filter 36), means (subtractor 37) for generating a differential signal between the two signals passed through the first and second frequency filters, and an adder-subtractor circuit (adder 38) which generates a combined RF signal by addition/subtraction of the differential signal and the signal detected by the first signal detection unit.

If there is no difference between the signals (RF signals) corresponding to recorded data detected by the first and second signal detection units, an offset signal (differential signal) will be zero at any frequency. Only if there is a difference, the offset signal (differential signal) is generated and added to the original signal (signal detected by the first signal detection unit). With regard to the signal having the high-frequency component that does not pass (not cut off) through the frequency filter, the differential signal is also zero and, therefore, the original signal (detected by the first signal detection unit) is output as is without being added with the offset signal. In this manner, even if the AC amplifier is employed to amplify the signal detected by the first signal detection unit, the lost low-frequency component of the signal in the vicinity of DC during amplification by the AC amplifier can be compensated by the other signal detected by the second signal detection unit. In this arrangement, the DC amplifier output signal with low noise in the low frequency domain is available at lower frequencies and the AC amplifier output signal with low noise in the high frequency domain is available at high frequencies. Because characteristically different signals can be combined, readout signals with even lower noise as a whole can be obtained.

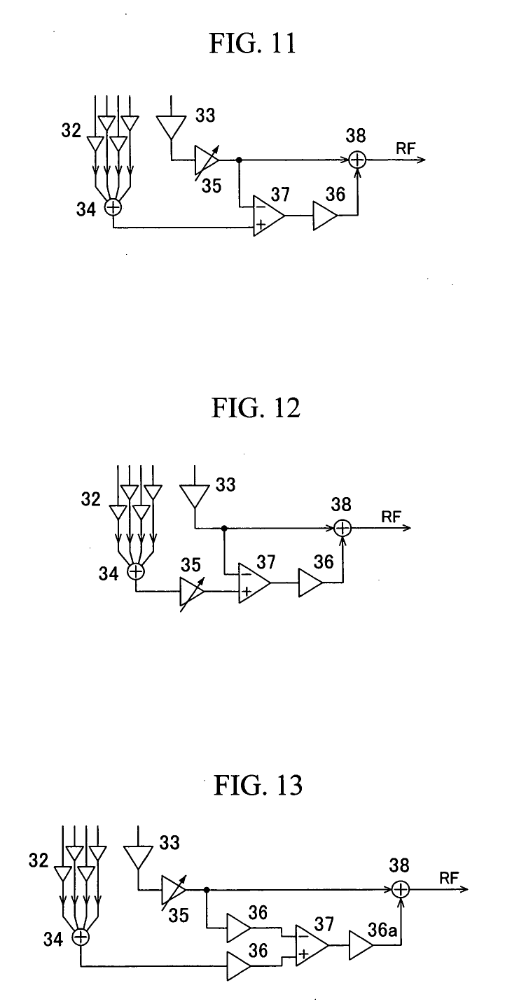

In this relation, in order to coordinate the sensitivity of the RF signal output by the AC amplifier and the sensitivity of the RF signal, the sum of the signals output by the DC amplifiers at the same level, the gain adjuster 35 is inserted on one circuit path. The gain adjuster 35 may be inserted on the path of the first RF signal (i.e., RF signal output from the AC amplifier), as shown in FIG. 1, or on the path of the second RF signal (i.e., RF signal, the sum of the signals output by the DC amplifiers), as shown in FIG. 10. A low-pass filter may be inserted after the subtractor, as is shown in FIG. 11, not only before the subtractor 37. By combination of these configurations, the circuitry may be configured as is shown in FIG. 12. The gain adjuster 35 may be incorporated into the DC photocurrent amplifiers 32 or the RF signal photocurrent amplifier 33. The gain adjuster is not always embodied in an amplifier and may be embodied in an element such as a semi-fixed resistor capable of variably adjusting the attenuation amount.

As shown in FIG. 1 and FIG. 10, in an instance where the low-pass filters are inserted before the subtractor 37, it is needed to ensure that the two low-pass filters 36 have the same cut-off characteristics in order to generate a correct differential signal. By using the low-pass filters with the same characteristics, a correct offset signal can be generated and two RF signals, one in the low frequency domain and the other in the high frequency domain, can be mixed without distortion. The cut-off characteristics may be substantially the same, as long as providing sufficient effects, even if not completely the same. In this configuration where two low-pass filters 36 are inserted before the subtractor 37, the circuit performance is easy to stabilize because high frequency components are prevented from entering the subtractor, though two low-pass filters are needed. Meanwhile, in the configurations shown in FIG. 11 and FIG. 12, one low-pass filter 36 is only needed. These configurations have an advantage that high frequency noise generated by the subtractor 37 can be removed by the low-pass filter 36 following the subtractor 37.

Specifically, this arrangement includes the optics section primarily comprising a light source which emits a light beam that irradiates an information recording medium and photodetectors for optically detecting a recorded signal on the medium from a beam reflected from the medium, the photodetectors including the first signal detection unit (RF signal detector plane 30) and the second signal detection unit (four-quadrant photodetector planes 29). As shown in FIG. 11 and FIG. 12, this arrangement further includes circuitry comprising means (subtractor 37) for generating a differential signal between the two signals detected by the first and second signal detection unit, a frequency filter (low-pass filter 36) which cuts off the high-frequency component of the differential signal, and an adder-subtractor circuit (adder 38) which generates a combined RF signal by addition/subtraction of the signal passed through the frequency filter and the signal detected by the first signal detection unit.

Taking advantage of the merits of both the configurations of FIG. 1 and FIG. 11, another low-pass filter 36a can be inserted after the subtractor 37 in addition to the filters before the subtractor 37, as is shown in FIG. 13. Whether the frequency filter is inserted after the subtractor 37 in this way, or inserted before the subtractor 37, its effect is basically the same. The frequency filter mentioned hereinafter will be assumed as the one that cuts off a frequency component of the differential signal, whether it is located before or after the subtractor. Essentially, the present invention is characterized in that a plurality of RF signal detection units are provided and a combined RF signal with low noise is obtained by addition/subtraction between the plurality of RF signals filtered through the frequency filters. The circuitry may be configured or modified in several forms, as shown in FIG. 1 or FIGS. 10 through 13.

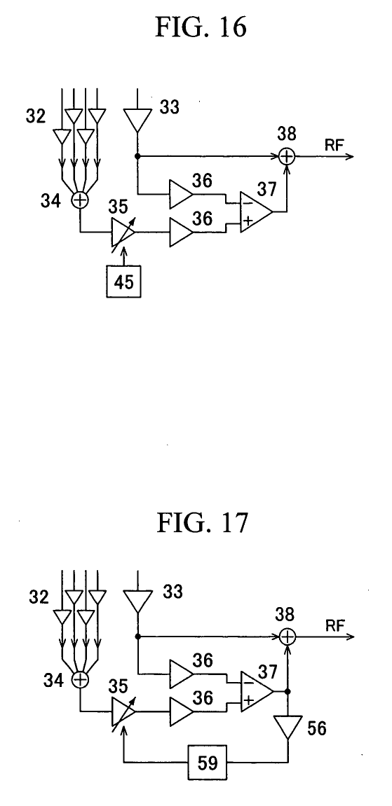

The circuitry may also be configured such that the gain of the gain adjuster 35 is adjusted by a main controller 45, as shown in FIG. 15 and FIG. 16. When the wavelength of the source beam that irradiates the information recording medium is switched from one to another, the diffraction efficiency of the diffraction grating and the reflectance and transmittance of a beam splitter and a reflecting mirror change, depending on the wavelength. Upon wavelength switchover, gain is changed by the main controller 45. Wavelength sensitivity characteristics of photodetectors may differ, depending on their material; e.g., silicon semiconductor photodetectors and compound semiconductor photodetectors. In view hereof, gain is adaptively changed by the main controller 45 upon wavelength switchover. By changing the gain upon wavelength switchover, the gains of the first and second RF signals can be adjusted properly and combined RF signals without distortion can be obtained in the optical information reproduction apparatus configured to be compatible with multiple standards.

In stead of the above gain change control, it is also possible to detect the amplitudes of the first and second RF signals and make automatic gain adjustment. A concrete example of this automatic gain adjustment method will be discussed in the following section of Fourth Embodiment. In the present embodiment, because the four-quadrant photodetector 29 which is the second RF signal detection unit also serves as an AF signal and TR signal detection unit, beam splitting should be performed once only for RF signal combining purposes and a decrease in the S/N ratio by beam splitting can be suppressed to a minimum level. The gain adjuster may be mounted on a moving part of the optical pickup assembly or on a signal processing circuit substrate in the stationary part. In an instance where the gain adjuster 35 is inserted on the path of the AC amplifier side (first RF signal path), as shown in FIG. 1, gain is adjusted to the gain of the second RF signal having stable characteristics. Advantage hereof is that the intensity of combined RF signals is easy to stabilize and variation among products can be decreased. In another instance where the gain adjuster 35 is inserted on the path of the DC amplifiers side (second RF signal path), the first RF signal with a wide bandwidth is not deteriorated and advantage hereof is that the noise of combined RF signals can keep low.

### Fourth Embodiment

(Automatic Gain Control in the First Arrangement for Generating Combined RF Readout Signals)

A circuitry configuration example where automatic gain control for coordinating the first and second RF signals is performed, according to the present invention, is discussed, using FIGS. 17 through 20. An embodiment of the RF signal combining circuitry having an automatic gain adjustment function according to the present invention is shown in FIG. 17. FIG. 17 shows a configuration example where the gain control described for FIG. 16 is performed by detecting the amplitude of a differential signal.

A light signal amplified by the RF signal photocurrent amplifier 33 is output as the first RF signal. On the other hand, light signals detected by the four-quadrant photodetector planes and amplified by four DC photocurrent amplifiers 32, respectively, are added by the adder 34 into the second RF signal. The second RF signal passes through the gain adjuster 35 and its sensitivity in the low frequency domain is adjusted to be equivalent to that of the first RF signal. From these first and second RF signals, signal components in the low frequency domain are extracted through two low-pass filters 36 with the same cut-off characteristics. A differential signal between the two RF signals passed through the low-pass filters 36 is output from the subtractor 37. After a signal portion in the vicinity of 0 Hz is removed from the differential signal by a high-pass filter 56, the amplitude of the differential signal is detected by an amplitude detector 59. The gain of the gain adjuster 35 is controlled so that the above amplitude will be minimized. As the gain adjuster 35, for example, a voltage control variable gain amplifier configured with field effect transistors may be used.

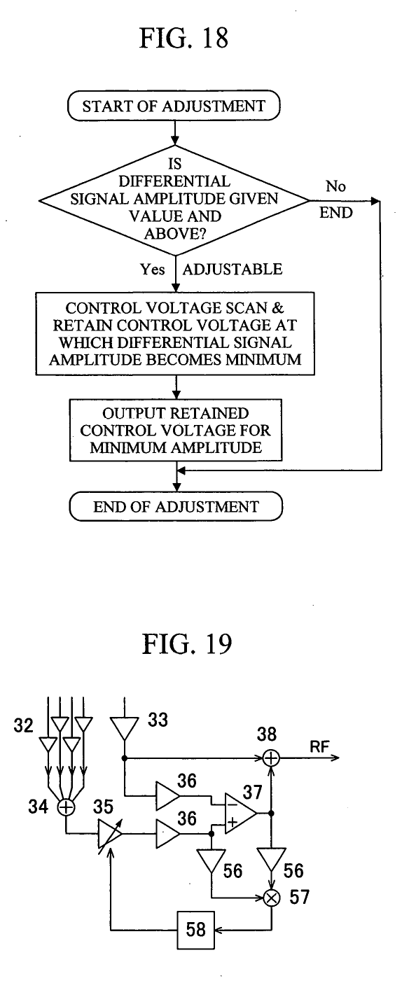

In this configuration, to adjust the amplitudes of the first and second RF signals, common gain portions 77 after the signals pass through the low-pass and high-pass filters are extracted out of AC amplifier gain 72 and DC amplifier gain 73 shown in FIGS. 7A and 7B. The gain is controlled so that a differential amplitude between the common gain portions will be minimized. Thereby, the intensities (sensitivities) of the first and second RF signals are coordinated at the same level. For this purpose, both the low-pass filters 36 and the high-pass filter 56 are employed and only signal portions within a frequency bandwidth for the gain portions 77 after the signals pass through the low-pass and high-pass filters are extracted. The amplitude detector 59 controls the gain of the gain adjuster 35 so that the thus obtained differential amplitude will be minimized, according to a procedure which is illustrated in FIG. 18. In particular, adjustment is made, according to the following procedure.

If the amplitude of the differential signal passed through the high-pass filter, input to the amplitude detector, is below a given value, adjustment is not performed. Only when the amplitude is the given value and above, adjustment is performed. For adjustment, first, a control voltage scan from a voltage that makes a slight decrease in gain to a voltage that makes a slight increase in gain is performed. During the scan, a control voltage at which the detected amplitude has become minimum is retained on the amplitude detector 59. After the scan, the control voltage is updated to that voltage at which the amplitude has become minimum.

By repeating the above control voltage update at intervals of a given time period, the amplitude of the differential signal output from the subtractor 37 can be maintained at a minimum level so as to approximate zero. In this configuration, the gain of the gain adjuster can be adjusted automatically by using a relatively simple circuit for amplitude detection.

Next, a second embodiment of the RF signal combining circuitry having the automatic gain adjustment function according to the present invention is shown in FIG. 19. FIG. 19 shows a configuration example where the gain control described for FIG. 16 is automatically performed by correlation calculation for the differential signal and the original RF signal.

A light signal amplified by the RF signal photocurrent amplifier 33 is output as the first RF signal. On the other hand, light signals detected by the four-quadrant photodetector planes and amplified by four DC photocurrent amplifiers 32, respectively, are added by the adder 34 into the second RF signal. The second RF signal passes through the gain adjuster 35 and its sensitivity in the low frequency domain is adjusted to be equivalent to that of the first RF signal. From these first and second RF signals, signal components in the low frequency domain are extracted through two low-pass filters 36 with the same cut-off characteristics. A differential signal between the two RF signals passed through the low-pass filters 36 is output from the subtractor 37. From the differential signal, a signal portion in the vicinity of 0 Hz is removed by a high-pass filter 56. Meanwhile, from the original second RF signal also, a signal portion in the vicinity of 0 Hz is removed by another high-pass filter 56. The signals passed through the two high-pass filters 56 are multiplied in real time by a multiplier 57. The multiplier output signal is integrated by an integrator 58. As the integrator, an inverting integrator is employed; for instance, when a positive voltage is applied to the integrator input, the integrator output voltage drops.

For the gain adjuster 35, for example, a voltage control variable gain amplifier configured with field effect transistors may be used; its output gain increases as the input voltage increases. Feedback control is realized by applying the integrator output voltage to the gain adjuster 35. In particular, when the differential signal has an in-phase component with respect to the second RF signal, the output gain of the gain adjuster 35 decrease; when the differential signal has an inverse phase to the second RF signal, the output gain increase. Thereby, the gain is always controlled so that signal amplitude difference between the first RF signal and the second RF signal passed through the gain adjuster 35 will be zero in the frequency range of common gain portions 77 after the signals pass through the low-pass and high-pass filters, as illustrated in FIGS. 7A and 7B. Thereby, adjustment is automatically performed so that the sensitivities of the first and second RF signals after being amplified will be equal.

In this configuration, because correlation calculation by the multiplier is used as means for detecting differential signal amplitude, even if the differential signal amplitude is in the vicinity of zero, exact feedback control to increase or decrease gain can be performed. In the above configuration, because the gain adjuster is located on the path of the second RF signal, the first RF signal is not deteriorated and advantage hereof is that the noise of combined RF signals can keep low eventually.

Conversely, it is also possible to locate the gain adjuster on the path of the first RF signal and adjust the gain of the first RF signal to the second RF signal. This can be realized by, for instance, employing a non-inverting integrator as the above integrator 58. In this case, because the first RF signal gain is controlled to be tuned to the second RF signal, a stable signal obtained from the DC amplifiers can be used as the reference and advantage hereof is that the intensity of combined RF signals is easy to stabilize.

In any configuration shown in FIG. 1 or FIGS. 10 through 13, the gain of the gain adjuster 35 can be adjusted automatically in the same principle as described above. In the method of the adjustment, means for variably changing the gain is provided, a differential signal between two RF signals is detected, and the gain is changed so that the differential signal amplitude will be minimized.

While the method of automatically adjusting the gain of the gain adjuster 35 by feedback control was described above, as a simple method, a semi-fixed variable resistor or the like may be installed on the optical head (pickup) to allow for manual gain adjustment. In most cases, even by manual gain adjustment, the effect of reducing the noise of combined RF signals well can be obtained sufficiently. In other words, the gain adjuster may be present on the head assembly. The automatic gain adjustment, not manual adjustment, is advantageous in that it can adjust RF signal gain automatically, adaptive to change in the AC amplifier gain due to condition variation of ambient environment and temperature characteristics and instability of the AC amplifier.

### Fifth Embodiment

(Entire Configuration of the Information Reproduction Apparatus)

Next, an embodiment of an entire configuration of the information reproduction apparatus according to the present invention is discussed, using FIG. 20. An optical disk 7 which is a recording medium is mounted on a spindle motor 9 whose revolving speed is controlled by a spindle motor controller 8. This medium is irradiated with light from semiconductor lasers 11a, 11b, 11c driven by laser drivers 10a, 10b, 10c. The semiconductor lasers 11a, 11b, 11c emit light beams with different wavelengths; a blue light semiconductor laser 11a, a red light semiconductor laser 11b, and an infrared light semiconductor laser 11c are employed. The beams of the semiconductor lasers 11a, 11b, 11c respectively pass through diffraction gratings 12a, 12b, 12c for the three-spot method and collimating lenses 13a, 13b, 13c. Only the blue light semiconductor leaser beam further passes through a beam shaping prism 14.

The beam of the semiconductor laser 11b is turned by a reflector mirror 15 and directed toward the disk 7. The beam of the semiconductor laser 11c is turned by a combination prism 16a, combined with the beam from the semiconductor laser 11b, and directed toward the disk 7. The beam of the semiconductor laser 11a is turned by a combination prism 16b, combined with the beams from the semiconductor lasers 11b, 11c, and directed toward the disk 7. Then, each laser beam passes through a polarizing beam splitter 17, a liquid crystal wavefront corrector 18, and a quarter-wave plate 19, and focused on the disk 7 by an objective lens 20.

The objective lens 20 is mounted on an actuator 21 and the focus position can be moved in the direction of depth of focusing (focus direction) by a signal from a focus servo driver 22 and in the track direction by a signal from a tracking servo driver 23. At this time, an error in thickness of the disk 7 substrate and spherical aberration caused by the objective lens 20 are corrected by the liquid crystal wavefront corrector 18. The spherical aberration corrector, according to a control voltage from the main controller 45, generates different refractive index distributions for the inner and outer circumferences of a beam, corrects a wavefront lead and lag and corrects the spherical aberration. By correcting the spherical aberration, light can be focused at a sufficiently small spot. With this light, the head reads a pattern of microscopic marks recorded on the disk 7 or records a pattern of marks. A part of the beam striking the disk 7 is reflected and passes through the objective lens 20, quarter-wave plate 19, and liquid crystal wavefront corrector 18 again, and is deflected toward a cylindrical lens 25 by the polarizing beam splitter 17. The deflected beam passes through the cylindrical lens 25 and a detection lens 26 and is split by a diffraction grating 27. Firs-order beam components diffracted by the diffraction grating 27 are detected by the RF signal detector plane on a photodetector chip 28 and converted into an electric signal. This electric signal is amplified by the RF signal photocurrent amplifier 33 and a first readout signal (RF signal) is generated.

On the other hand, zero-order beam components not diffracted by the diffraction grating 27 are detected by the four-quadrant detector planes on the photodetector chip 28 and converted into electric signals which are amplified by the DC photocurrent amplifiers 32. Through addition/subtraction of the thus amplified signals, the focus servo driver 22 generates a focus error signal and the tracking servo driver 23 generates a tracking error signal. The amplified signals are added by the adder 34 into a second readout signal (RF signal). The detector planes on the photodetector chip 28 can be arranged, as shown in FIG. 1 and FIG. 14.

The second readout signal, after passing through the gain adjuster 35 and one low-pass filter 36, is supplied to one input of the subtractor 37. On the other hand, the first readout signal is supplied through the other low-pass filter to the other input of the subtractor 37 and directly supplied to the adder 38. At the subtractor 37, a differential signal between these readout signals is generated and supplied to the adder 38 and the high-pass filter 39. The high-pass filter outputs the differential signal from which the frequency component in the vicinity of DC was removed and supplies that signal to a gain controller 40 including an amplitude detecting means. According to the detected differential signal, the gain controller 40 changes the voltage to be output to the gain adjuster 35 and controls the gain so that the amplitude of the differential signal will be minimized. The gain controller 40 is able to change the gain control by a command from the main controller 45, according to source beam wavelength switchover or apparatus status. The adder 38 generates a sum signal of the differential signal and the first readout signal. This sum signal is a combined readout signal (combined RF signal).

The combined readout signal passes through an equalizer 41, a level detector 42, and a synchronous clock generator 43, and, at a decoder 44, it is converted into an original digital signal that was recorded formerly. Concurrently, the synchronous clock generator 43 directly detects the combined readout signal and generates and supplies a sync signal to the decoder 44. A series of these circuits operates under an overall control of the main controller 45.

Specifically, this apparatus configuration includes a first light source (semiconductor laser 11a) which emits a light beam with a first wavelength, a second light source (semiconductor laser 11b) which emits a light beam with a second wavelength, and a third light source (semiconductor laser 11c) which emits a light beam with a third wavelength, as light sources. The four-quadrant photodetector is employed as the AF signal detection unit and zero-order beams with first, second, and third wavelengths are detected by the same four-quadrant photodetector.

By using this configuration, a highly reliable information reproduction apparatus that reproduces information recorded on a recording medium, using source beams with three different wavelengths, can be realized. Because a common photodetector chip can be used for the source beams with three different wavelengths, this apparatus is low cost. Switches and associated circuits are not required for switching between photodetector planes and smaller and compact circuitry is feasible. Because detected readout signals are amplified by specially designed, low noise amplifiers, the amplified signals are high speed and low noise. By way of AC amplifiers and compound semiconductor transistors, further noise reduction is feasible. Thus, information reproduction apparatus for high-speed and high-density optical disks and the like can be realized. Typically, limitations of reproduction speed of optical information reproduction apparatus, attributed to laser photocurrent amplifier noise, can be overcome, and the reproduction speed can be enhanced to 150 Mbps or higher, while high reliability is sustained. The above noise and speed limitation and the effect of the present invention will be described in the section of Ninth Embodiment.

### Sixth Embodiment

(Second Arrangement for Generating Combined RF Readout Signals)

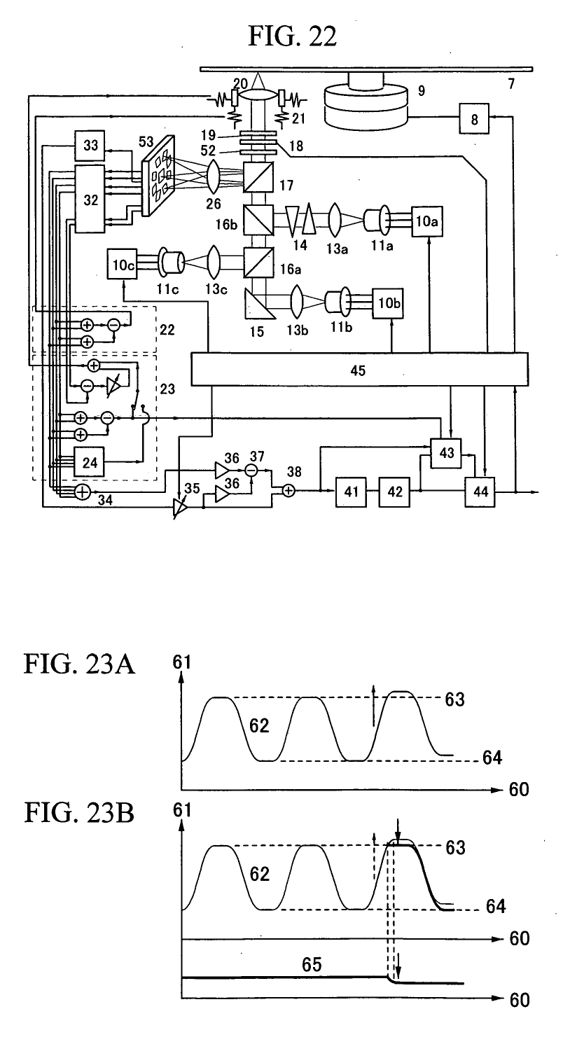

Next, another configuration example of the information reproduction apparatus including circuitry for combining low noise RF signals, according to the present invention, is discussed, using FIGS. 21 and 22. First, another arrangement example of photodetectors is shown in FIG. 21. In the foregoing embodiments, the optics section is configured such that first-order (diffracted) beams are detected by the RF signal detector plane and zero-order beams are detected by the four-quadrant photodetector (also used for AF and TR detection). Instead of using the four-quadrant photodetector, a polarization grating divided into four subdivisions with different grooves that diffract beams in different directions, as is shown in FIG. 21A, may be used; then, photodetection similar to the four-quadrant photodetector can be carried out without using such photodetector. The principle of arrangement of this photodetecting optics section is shown in FIG. 21B.

FIG. 21B shows the optics section from the objective lens 20 to photodetector planes, reduced and simplified for explanatory purposes. Directly under the objective lens 20, a quarter-wave plate 19 and a polarization grating 52 are located. The polarization grating 52 is a special diffraction grating characterized in that it may or may not diffract light, according the polarization direction of light passing it. When a beam from a semiconductor laser travels forward toward an optical disk as a recording medium, diffraction does not take place on account of the laser polarization. After passing through the quarter-wave plate 19 and objective lens 20, when a beam reflected by the optical disk medium travels backward through the objective lens 20 and quarter-wave plate 19, its polarization direction becomes perpendicular to the original laser beam upon passing across the quarter-wave plate twice. Then, the beam is diffracted by the polarization grating 52 and slit into beam components which travel in four directions according to the subdivisions (assuming that plus and minus first-order diffraction occurs, the beam is split into beam components that travel in eight directions altogether).

The diffracted beams (first-order) are detected by a plurality of diffracted beam detector planes 55 arranged on a photodetector device 53. Through addition/subtraction of these detected signals, AF signals, TR signals, and RF signals can be generated, in the same way as for the four-quadrant photodetector planes. On the other hand, zero-order beams not diffracted by the polarization grating 52 are detected by an RF signal detector plane 54 the center of the photodetector device 53. Thus, the first RF signal can be obtained by the central RF signal detector plane 54 and the second RF signal be obtained through addition/subtraction of the signals detected by the plurality of diffracted beam detector planes 55 arranged around the central plane. As in the fifth embodiment, by combining the RF signals, low noise readout signals can be obtained. Ratio between the first-order and zero-order beams in the amount of light can be adjusted by adjusting the groove duty ratio (groove width ratio) and groove depth of the diffracting grating.

An embodiment of an entire configuration of the information reproduction apparatus employing this polarization grating and the photodetector device is discussed, using FIG. 22. An optical disk 7 which is a recording medium is mounted on the spindle motor 9 whose revolving speed is controlled by the spindle motor controller 8. This medium is irradiated with light from the semiconductor lasers 11a, 11 b, 11c driven by laser drivers 10a, 10b, 10c. The semiconductor lasers 11a, 11b, 11c emit light beams with different wavelengths; the blue light semiconductor laser 11a, red light semiconductor laser 11b, and infrared light semiconductor laser 11c are employed. The beams of the semiconductor lasers 11a, 11b, 11c respectively pass through the collimating lenses 13a, 13b, 13c. Only the blue light semiconductor leaser beam further passes through the beam shaping prism 14.

The beam of the semiconductor laser 11b is turned by the reflector mirror 15 and directed toward the disk 7. The beam of the semiconductor laser 11c is turned by one combination prism 16a, combined with the beam from the semiconductor laser 11b, and directed toward the disk 7. The beam of the semiconductor laser 11a is turned by the other combination prism 16b, combined with the beams from the semiconductor lasers 11b, 11c, and directed toward the disk 7. Then, each laser beam passes through the polarizing beam splitter 17, liquid crystal wavefront corrector 18, and quarter-wave plate 19, and focused on the disk 7 by the objective lens 20.

The objective lens 20 is mounted on the actuator 21 and the focus position can be moved in the direction of depth of focusing (focus direction) by a signal from the focus servo driver 22 and in the track direction by a signal from the tracking servo driver 23. At this time, an error in thickness of the disk 7 substrate and spherical aberration caused by the objective lens 20 are corrected by the liquid crystal wavefront corrector 18. The spherical aberration corrector, according to a control voltage from the main controller 45, generates different refractive index distributions for the inner and outer circumferences of a beam, corrects a wavefront lead and lag and corrects the spherical aberration. With this light, the head reads a pattern of microscopic marks recorded on the disk 7 or records a pattern of marks. A part of the beam striking the disk 7 is reflected and passes through the objective lens 20, quarter-wave plate 19, and liquid crystal wavefront corrector 18 again, and is then diffracted by the polarization grating 52 and split into beams angled at slightly different angles. These beams (zero-order and first-order beams) are then deflected toward the detection lens 26 by the polarizing beam splitter 17. The deflected beams, after passing through the detection lens 26, are detected by the detector planes on the photodetector device 53 and converted into an electric signal. A pattern of the detector planes is formed on the photodetector device 53, as shown in FIG. 21B. The beams are detected by the diffracted beam detector planes and the RF signal detector plane. Beams (zero-order) transmitted through the polarization grating 52 are detected by the RF signal detector plane and converted into an electric signal. This electric signal is amplified by the RF signal photocurrent amplifier 33 and a first readout signal (RF signal) is generated.

On the other hand, beams (first-order) diffracted by the polarization grating 52 are detected by the diffracted beam detector planes on the photodetector device 53 and converted into electric signals which are amplified by the DC photocurrent amplifiers 32. Through addition/subtraction of the thus amplified signals, the focus servo driver 22 generates a focus error signal and the tracking servo driver 23 generates a tracking error signal. The amplified signals are added by the adder 34 into a second readout signal (RF signal).

The second readout signal, after passing through one low-pass filter 36, is supplied to one input of the subtractor 37. On the other hand, the first readout signal, after passing through the gain adjuster 35, is supplied through the other low-pass filter to the other input of the subtractor 37 and directly supplied to the adder 38. At the subtractor 37, a differential signal between these readout signals is generated and supplied to the adder 38. The adder 38 generates a sum signal of the differential signal and the first readout signal. This sum signal is a combined readout signal (combined RF signal). The gain of the gain adjuster 35 can be changed by a command from the main controller 45, according to source beam wavelength switchover or apparatus status.

The combined readout signal passes through the equalizer 41, level detector 42, and synchronous clock generator 43, and, at the decoder 44, it is converted into an original digital signal that was recorded formerly. Concurrently, the synchronous clock generator 43 directly detects the combined readout signal and generates and supplies a sync signal to the decoder 44. A series of these circuits operates under an overall control of the main controller 45. Specifically, in this configuration, instead of the four-quadrant photodetector, the polarization grating (with four subdivisions) for beam splitting is inserted in front of the detector planes of the first and second RF signal detection units.

By using this configuration as well, a highly reliable information reproduction apparatus that reproduces information recorded on different types of recording media which conform to different standards in a compatible manner, using source beams with three different wavelengths, can be realized. Because a common photodetector device can be used to generate both first and second RF signals, a plurality of photodetector devices are not needed and this apparatus is low cost. Diffracted beam detector planes need to be divided so that switching among them can be performed, according to applied wavelength out of the source beams with three different wavelengths. However, switches and associated circuits for wavelength switchover are not required, as diffraction angles are adjusted to accommodate the different wavelengths, and smaller and compact circuitry is feasible. Because the RF signal detector plane detects non-diffracted beams (zero-order), the light spot is not displaced by wavelength switchover. The same RF signal detector plane can be used to detect beams of three wavelengths and its area can be reduced. Advantage hereof is that low noise RF signal detection can be performed at a high speed.

As is the case for the fifth embodiment, because detected readout signals are amplified by specially designed, low noise amplifiers, the amplified signals are high speed and low noise. By way of AC amplifiers and compound semiconductor transistors, further noise reduction is feasible. Thus, information reproduction apparatus for high-speed and high-density optical disks and the like can be realized. Typically, limitations of reproduction speed of optical information reproduction apparatus, attributed to laser photocurrent amplifier noise, can be overcome, and the reproduction speed can be enhanced to 150 Mbps or higher, while high reliability is sustained.

Combination of the fifth and sixth embodiments may be applied to configure the optics section and associated circuitry. For instance, if the arrangement of the detector planes shown in FIG. 21B without the RF signal detector plane 54 is already used, the present apparatus can be realized by adding the RF signal detector plane 54 and by adjusting the groove duty ratio (groove width ratio) and groove depth of the polarization grating 52. As in the configurations according to the third through sixth embodiments, with the use of combined RF signals in which the RF signals on two paths are combined and their desired bandwidths are mixed, a conventional decoder can be used as is for the subsequent decoder. In this method, the arrangement of the optics section except for the photodetector device and the diffraction grating is the same as conventional one. Because, in the optical head assembly, the same components and circuits as in the conventional optics section can be used as is, the apparatus hardware cost is reduced advantageously.

### Seventh Embodiment

(Clipping Follow-Up Correction)

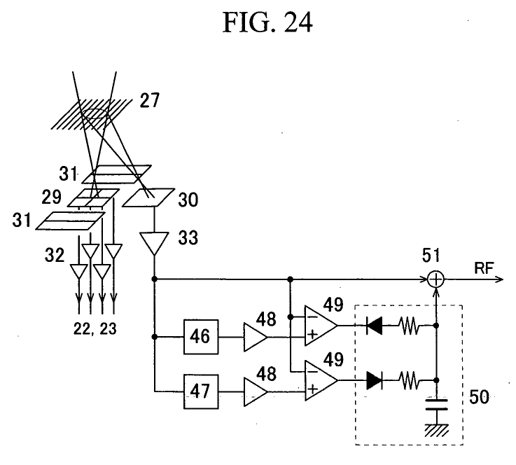

Next, a configuration example of the information reproduction apparatus where a plurality of readout signals output from the AC and DC amplifiers are separately used and a readout signal from a low noise AC amplifier is directly used and its effect, according to the present invention, are discussed, using FIGS. 23 and 24. First, the principle of clipping correction by follow-up in accordance with the present invention, which is significantly effective when AC amplifier output signals are directly decoded as readout signals, is described.

FIG. 23A shows signal transition appearing when an AC amplifier, in particular, the one configured with compound semiconductor field-effect transistors, according to the present invention, is used. The abscissa denotes time 60 and the ordinate denotes amplified signal voltage 61. For the photocurrent amplifier employing field-effect transistors, described above for FIG. 8A, small jitters always occur due to 1/f noise in the low frequency domain of amplified signals. For example, a readout signal 62 (RF signal) for a long mark iterative pattern, amplified with compound semiconductor field-effect transistors, repeatedly rises and falls between the peak voltage 63 and bottom voltage 64 of the readout signal, saturated at the peak and bottom, if retrieved normally. However, when the source-drain current of the field-effect transistors varies (jitters), affected by 1/f noise, the waveform of this readout signal 62 shifts up or down, continuing to exceed either the peak 63 or bottom 64 level (FIG. 23A). Either an excess above the peak or shortage below the bottom, which continues, is detected. By adding a voltage to offset the excess of shortage (offsetting voltage 65), correction is made so that the signal properly falls between the peak 63 and bottom 64 levels. The thus corrected signal has less possibility of errors when the level is detected. In this way, readout signals are followed up and corrected, if necessary, so that they will be decoded properly.

This method is significantly effective for photocurrent amplifiers configured with transistors made of semiconductor materials, particularly, gallium arsenide (GaAs). Since GaAs has two points of stabilizing carrier velocity in carrier dispersion in a semiconductor, it has a drawback that 1/f noise is somewhat greater than field-effect transistors employing silicon semiconductors. The signal zero point and amplification factor (gain) are liable to change as the amount of current changes. By correcting fluctuations in the DC level through this method, jitters can be improved and the reliability of readout signals and decoded information can be enhanced. In the following, this correction method will be referred t as clipping follow-up correction.

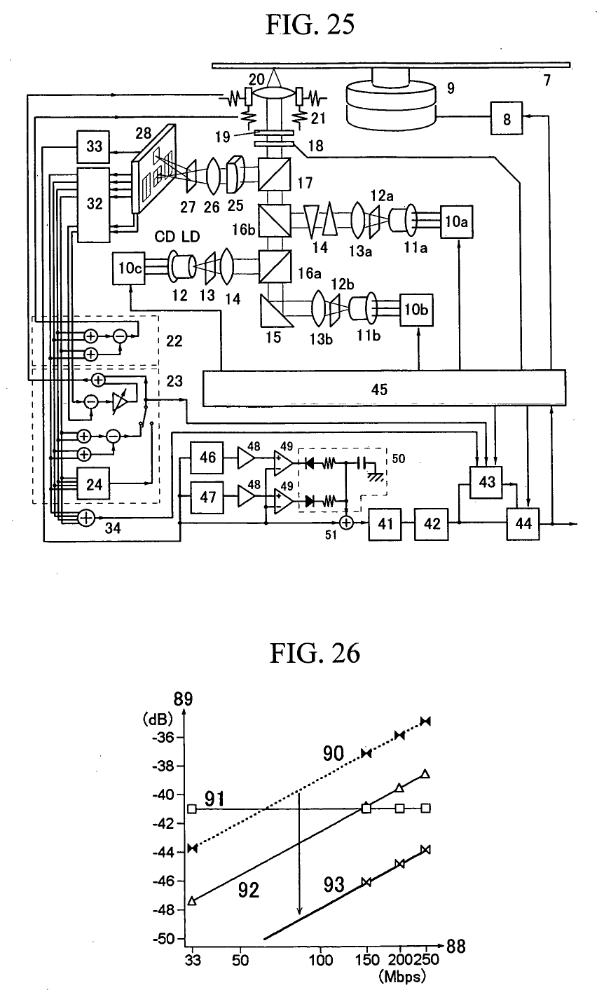

Next, an example of circuitry of a clipping follow-up correction unit according to the present invention is discussed, using FIG. 24. FIG. 24 shows the photodetecting optics section of the optical head and the circuitry in the vicinity of that section (optical head) in the optical information reproduction apparatus. A diffraction grating located in front of the photodetector chip splits an incident beam to the photodetectors into two or more beam components. In FIG. 24, TR signal and AF signal detection by the three-spot method is assumed again. The related entire apparatus configuration will be described in the section of Eighth Embodiment, using FIG. 25.

Among three spot beams directed to hit the photodetectors, a center spot beam is split by the diffraction grating 27 into a zero-order beam which is detected by the four-quadrant photodetector 29 and a first-order diffracted beam which is detected by the RF signal detector plane 30. As the diffraction grating, for example, a blaze-type grating is used. Two sub-spot beams at both sides, which are not shown in FIG. 24, are detected by sub-spot detector planes 31 and used for TR signal detection by the differential push-pull (DPP) method. Current for the light signal detected by the RF signal detector plane 30 is amplified by the RF signal photocurrent amplifier 33 and a first RF signal is output. As the RF signal photocurrent amplifier, either a DC amplifier or an AC amplifier may be used. Currents for the light signals detected by each plane of the four-quadrant photodetector 29 are amplified by four DC photocurrent amplifiers 32, respectively and used for AF signal and TR signal generation. On the other hand, the first RF signal is supplied to a peak-hold circuit 46 and a bottom-hold circuit 47. Using the signals amplified by the four DC photocurrent amplifiers 32, it is also possible to generate and use a second RF signal for synchronization as well as AF and TR signals.

The peak-hold circuit 46 is a generally used one that holds and outputs a maximum voltage. The bottom-hold circuit 47 is also a generally used one that holds and outputs a minimum voltage. Signals output from these peak-hold circuit 46 and bottom-hold circuit 47, after passing through low-pass filters 48 having a cut-off frequency lower than the minimum modulation frequency of a readout signal, are supplied to differential amplifiers 49, respectively. The first differential amplifier outputs a differential signal of the peak voltage passed through the low-pass filter from the first RF signal. The second differential amplifier 49 outputs a differential signal of the bottom voltage from the first RF signal. The respective signals output from the two differential amplifiers 49 are supplied to an offset voltage hold circuit 50. The offset voltage hold circuit 50 performs charging/discharging of DC voltage held on a capacitor for an excess of voltage above the peak voltage, obtained as the differential, through an ideal diode. The DC voltage held on this offset voltage hold circuit 50 is added by an adder 51 to the first RF signal as a DC level offset. Thereby, a readout signal subjected to clipping follow-up correction is output from the adder 51.

Specifically, in this configuration example, the optics section primarily comprising a light source which emits a light beam that irradiates an information recording medium and photodetectors for optically detecting a recorded signal on the medium from a beam reflected from the medium, the photodetectors including the first RF signal detection unit (RF signal detector plane 30) and the second RF signal detection unit (four-quadrant photodetector planes 29). The optics section further includes an RF photocurrent amplifier, e.g., an AC amplifier, to amplify the signal detected by the first RF signal detection unit and DC amplifiers to amplify the signals detected by the second RF signal detection unit. Using the signals amplified by the DC amplifiers, auto-focusing control and tracking control are performed. Using the signal amplified by the AC amplifier, decoding readout information can be performed. Even if a DC amplifier is used as the RF photocurrent amplifier, the information reproduction apparatus according to the present invention is capable of correcting varying signal quality recorded on the disk medium and location-dependent errors and enhancing the reliability of information decoding. If an AC amplifier is used as the RF photocurrent amplifier, even if, e.g., compound semiconductor field-effect transistors are used to configure the photocurrent amplifier, jitters of readout signals affected by 1/f noise can be corrected and the reliability of information decoding can be enhanced.

Because RF signals are detected by a single detector plane dedicated to RF signal detection and amplified, readout signal quality (S/N ratio) can be improved, as compared with RF signals generated by adding four signals detected by each plane of the four-quadrant photodetector 29.

### Eighth Embodiment

(Entire Configuration of the Information Reproduction Apparatus Using Clipping Follow-Up Correction)

Next, an example of an entire configuration of the information reproduction apparatus using clipping follow-up correction of the foregoing seventh embodiment is discussed, using FIG. 25. An optical disk 7 which is a recording medium is mounted on the spindle motor 9 whose revolving speed is controlled by the spindle motor controller 8. This medium is irradiated with light from the semiconductor lasers 11a, 11b, 11c driven by laser drivers 10a, 10b, 10c. The semiconductor lasers 11a, 11b, 11c emit light beams with different wavelengths; the blue light semiconductor laser 11a, red light semiconductor laser 11b, and infrared light semiconductor laser 11c are employed. The beams of the semiconductor lasers 11a, 11b, 11c respectively pass through the diffraction gratings 12a, 12b, 12c for the three-spot method and the collimating lenses 13a, 13b, 13c. Only the blue light semiconductor leaser beam further passes through the beam shaping prism 14.

The beam of the semiconductor laser 11b is turned by the reflector mirror 15 and directed toward the disk 7. The beam of the semiconductor laser 11c is turned by one combination prism 16a, combined with the beam from the semiconductor laser 11b, and directed toward the disk 7. The beam of the semiconductor laser 11a is turned by the other combination prism 16b, combined with the beams from the semiconductor lasers 11b, 11c, and directed toward the disk 7. Then, each laser beam passes through the polarizing beam splitter 17, liquid crystal wavefront corrector 18, and quarter-wave plate 19, and focused on the disk 7 by the objective lens 20.

The objective lens 20 is mounted on the actuator 21 and the focus position can be moved in the direction of depth of focusing (focus direction) by a signal from the focus servo driver 22 and in the track direction by a signal from the tracking servo driver 23. At this time, an error in thickness of the disk 7 substrate and spherical aberration caused by the objective lens 20 are corrected by the liquid crystal wavefront corrector 18. The spherical aberration corrector, according to a control voltage from the main controller 45, generates different refractive index distributions for the inner and outer circumferences of a beam, corrects a wavefront lead and lag and corrects the spherical aberration. A part of the beam striking the disk 7 is reflected and passes through the objective lens 20, quarter-wave plate 19, and liquid crystal wavefront corrector 18 again, and is then deflected toward the cylindrical lens 25 by the polarizing beam splitter 17. The deflected beam passes through the cylindrical lens 25 and the detection lens 26 and is split by the diffraction grating 27. Firs-order beams diffracted by the diffraction grating 27 are detected by the RF signal detector plane on a photodetector chip 28 and converted into an electric signal. This electric signal is amplified by the RF signal photocurrent amplifier 33 and a first RF signal is generated. As the RF photocurrent amplifier, either a DC amplifier or an AC amplifier may be used.

On the other hand, zero-order beams not diffracted by the diffraction grating 27 are detected by the four-quadrant detector planes on the photodetector chip 28 and converted into electric signals which are amplified by the DC photocurrent amplifiers 32. Through addition/subtraction of the thus amplified signals, the focus servo driver 22 generates a focus error signal and the tracking servo driver 23 generates a tracking error signal. Using the signals amplified by the DC photocurrent amplifiers 32, it is also possible to generate and use a second RF signal for synchronization. In this case, a second RF signal is generated by the adder 34. This second readout signal (RF signal) is supplied to a synchronous clock generator 43 and used for sync signal generation. The amplified signals are added by the adder 34 into a second readout signal (RF signal). The detector planes on the photodetector chip 28 can be arranged, as shown in FIG. 1 and FIG. 14.

On the other hand, the first RF signal is supplied to the peak-hold circuit 46 and the bottom-hold circuit 47. The peak-hold circuit 46 is a generally used one that holds and outputs a maximum voltage. The bottom-hold circuit 47 is also a generally used one that holds and outputs a minimum voltage. Signals output from these peak-hold circuit 46 and bottom-hold circuit 47, after passing through the low-pass filters 48 having a cut-off frequency lower than the minimum modulation frequency of a readout signal, are supplied to the differential amplifiers 49, respectively. The first differential amplifier outputs a differential signal of the peak voltage passed through the low-pass filter from the first RF signal. The second differential amplifier 49 outputs a difference signal of the bottom voltage from the first RF signal. The respective signals output from the two differential amplifiers 49 are supplied to the offset voltage hold circuit 50. The offset voltage hold circuit 50 performs charging/discharging of DC voltage held on a capacitor for an excess of voltage above the peak voltage, obtained as the differential, through an ideal diode. The DC voltage held on this offset voltage hold circuit 50 is added by the adder 51 to the first RF signal as a DC level offset. Thereby, a readout signal subjected to clipping follow-up correction is output from the adder 51.

The readout signal subjected to clipping follow-up correction passes through the equalizer 41, level detector 42, and synchronous clock generator 43, and, at the decoder 44, it is converted into an original digital signal that was recorded formerly. A series of these circuits operates under an overall control of the main controller 45.

In the present configuration, by clipping follow-up correction, even if, e.g., compound semiconductor field-effect transistors are used to configure the photocurrent amplifier, jitters of readout signals affected by 1/f noise can be corrected and the reliability of information decoding can be enhanced. Even if a DC amplifier is used as the RF photocurrent amplifier, the information reproduction apparatus according to the present invention is capable of correcting varying signal quality recorded on the disk medium and location-dependent errors and enhancing the reliability of information decoding.

Because RF signals are detected by a single detector plane dedicated to RF signal detection and amplified, readout signal quality (S/N ratio) can be improved, as compared with RF signals generated by adding four signals detected by each plane of the four-quadrant photodetector 29. In the present configuration, because it is not needed to merge an RF signal amplified by the AC amplifier and an RF signal obtained by the DC amplifiers, obtained readout signals with optimal signal quality can be decoded, a high S/N ratio can be obtained, and the reliability of information decoding can be enhanced. In this configuration, by way of example, a second RF signal obtained from the four-quadrant photodetector may be used for synchronization detection. However, it is not mandatory to generate a second RF signal, using the signals detected by the four-quadrant photodetector, because synchronization detection can be performed with only the AC amplifier output (first RF signal) for some type of recording media like partial read only (ROM) optical disks.

The clipping follow-up correction allows for positive use of compound semiconductor transistors with an excellent S/N ratio in the high frequency domain. In consequence, optical information reproduction apparatus can be configured to well support blue light disks of strict S/N ratio requirements and high-speed performance over 150 Mbps. Highly reliable optical information reproduction apparatus with higher density and speed can be realized at low costs.

The clipping follow-up correction according to the present invention is also effective in combination with the fifth or sixth embodiment where first and second RF signals are combined into an RF signal in which desired bandwidths are merged. The optics section and associated circuitry may be configured in combination with the fifth or sixth embodiment. In this case, the clipping follow-up correction circuitry shown in FIG. 24 should be inserted, following the adder 34 or adder 38, so that the above-described advantage of the clipping follow-up correction can be achieved in the above embodiment as well.

In an instance where RF signals along two paths are detected and amplified and separately processed as in the configurations of the seventh and eighth embodiments, by well designing signal processing hardware to carry out synchronization detection and level correction with AC signals, not synchronization detection by mirror level and DC level detection, a significant increase in the order of 15 to 25 dB in the S/N ratio can be achieved. Specific advantage that noise generated in photocurrent amplifiers is minimized and excellent quality signals can be amplified can be provided.

### Ninth Embodiment

(S/N Ratio Improvement and Speeding Up Effects of the Present Invention)

When the above embodiments are applied to a higher-density optical disk apparatus using short wavelength light, their effects are discussed. As compared with Digital Versatile Disk (DVD) which prevails in the current market, the effect of the present invention is significant when the amount of light reflected from a light spot on the medium is cut to a half or less. If a phase change recording medium is used, the amount of reflected light (the amount of signal light) during a read is limited by light intensity density (light power density) on the recording layer. The maximum light power density not affecting data recorded on the medium is almost constant, not dependent on applied source beam wavelength. Thus, as the amount of signal light decreases, the S/N ratio deteriorates, even if noise is constant. For instance, in comparison with DVD, when the maximum amount of light of a readout signal is cut to a half, the wavelength of the light is:
650 nm÷\sqrt{2}≅460 nm Equation 1
For information reproduction apparatus, when reading an optical disk with a source beam with a wavelength of 460 nm and below, the effect of the present invention can be obtained significantly.

Then, the effect of speeding up by improved noise is considered. When the foregoing first embodiment is applied to reading a blue light disk with a 405-nm source beam, an example of the effect is discussed, using FIG. 26. FIG. 26 shows an example of actual measurements of change in noise intensity dependent on reproduction speed for major noise sources in a commercially available information reproduction apparatus with an optical disk medium. The abscissa denotes bit rate 88 and the ordinate denotes noise intensity 89. Three major sources of noise are: system noise intensity 90 including photocurrent amplifier noise; medium noise intensity 91 due to varying reflectance of disk medium; and laser noise intensity 92 due to variation in the amount of laser light as the light source. In this apparatus, at 65 Mbps and higher bit rates, greatest system noise (amplifier noise) occurs. In consequence, the bit rate is capped to on the order of 65 Mbps (at a point where the line of medium noise intensity 91 intersects with the line of system noise intensity 90).

By application of the present invention, the system noise intensity 90 can be improved by 9 dB, so noise can be suppressed to the line of improved system noise intensity 93. Thereby, while the bit rate was limited by the system noise conventionally, this limitation (to restrict the system noise) is removed in the information reproduction apparatus for optical disks to which the present invention was applied. Then, the bit rate can be enhanced to on the order of 150 Mbps at the next point where the line of medium noise intensity 91 intersects with the line of laser noise intensity 92.

By application of the present invention, thus, information reproduction apparatus for blue-light, high-density, optical disks, with a bit rate enhanced to 150 Mbps and above and keeping readout signal quality can be realized. Because amplifier noise can be further improved in combination with a high speed, low noise AC amplifier, even for the majority of information reproduction apparatus for optical disks in which amplifier noise greatly influences performance, the system noise restriction can be removed and a bit rate of 150 Mbps and above can be achieved.

By application of the present invention, signal quality is enhanced by using a high speed, low noise AC amplifier and signal compatibility with conventional circuits is maintained by combining signals detected by a plurality of photodetector planes. Because it is possible to continue to use the signal decoder circuit for conventional devices, a highly reliable information reproduction apparatus with high speed and high density performance can be realized at low costs.

It is also possible to use the foregoing embodiments in combination with the differential astigmatic method in which the photodetector planes shown in FIG. 14A are employed. In this case, auto-focusing control and tracking control are stabilized and excellent noise characteristics (a high S/N ratio) can be achieved. Advantage hereof is capability of enhancing density, speed, and reliability.

What is claimed is:

1. An information reproduction apparatus comprising:
a light source which emits a beam that irradiates an information recording medium;
a first diffraction grating which diffracts a beam emitted from said light source;
a second diffraction grating which diffracts a reflected beam from said information recording medium; and
a signal detection unit which receives said reflected beam and detects a signal, wherein said first diffraction grating is located between said light source and said information recording medium,
wherein said second diffraction grating is located between said information recording medium and said signal detection unit, and
wherein said signal detection unit comprising:
an AF signal detection unit which detects an AF signal from a zero-order beam transmitted through said second diffraction grating; and
an RF signal detection unit which exclusively detects a signal recorded on said information recording medium from a first-order beam diffracted by said second diffraction beam.

2. The information reproduction apparatus according to claim 1, wherein said light source comprises:
a first light source which emits a beam with a first wavelength;
a second light source which emits a beam with a second wavelength different from the first wavelength; and
a third light source which emits a beam with a third wavelength different from the first ad second wavelengths.

3. The information reproduction apparatus according to claim 1, wherein an AC amplifier is employed as an amplifier to amplify the signal detected by said RF signal detection unit.

4. The information reproduction apparatus according to claim 1, wherein said AF signal detection unit also serves as a second RF signal detection unit.

5. The information reproduction apparatus according to claim 4, further comprising:
an AC amplifier to amplify the signal detected by said RF signal detection unit; and
a DC amplifier to amplify the signal detected by said second RF signal detection unit.

6. The information reproduction apparatus according to claim 5, wherein said AC amplifier is configured with compound semiconductor transistors.

7. The information reproduction apparatus according to claim 1, wherein said signal detection unit further comprises:
a first and second photodetectors to detect a detracking amount,
wherein said AF signal detection unit is substantially located on a line connecting said first and second photodetectors, and
wherein said RF signal detection unit is located in such a position that a second line connecting said AF signal detection unit and said RF signal detection unit is substantially perpendicular to the first line.

8. The information reproduction apparatus according to claim 1, wherein said second diffraction grating is a blaze type.

9. The information reproduction apparatus according to claim 1, wherein said AF signal detection unit is a four-quadrant photodetector and a common detector to receive zero-order beams of said first, second and third wavelengths.

10. The information reproduction apparatus according to claim 1, wherein said AF signal detection unit and the first and second photodetectors to detect the detracking amount are three or more four-quadrant photodetectors.

11. An information reproduction apparatus comprising:
a light source which emits a beam that irradiates an information recording medium;
first and second signal detection units to detect a signal recorded on said information recording medium;
a first frequency filter which cuts off a given frequency component from the signal detected by said first signal detection unit;
a second frequency filter which cuts off a given frequency component from the signal detected by said second signal detection unit;
means for obtaining a differential signal between two signals passed through said first and second frequency filters; and
an adder-subtractor which performs addition/subtraction of said differential signal and the signal detected by said first signal detection unit.

12. The information reproduction apparatus according to claim 11, wherein said first and second frequency filters have substantially same cut-off frequencies.

13. An information reproduction apparatus comprising:
a light source which emits a beam that irradiates an information recording medium;
first and second signal detection units to detect a signal recorded on said information recording medium;
means for obtaining a differential signal between signals detected by said first and second signal detection units;
a frequency filter which cuts off a given frequency component from said differential signal; and
an adder-subtractor which performs addition/subtraction of the signal passed through said frequency filter and the signal detected by said first signal detection unit.

14. The information reproduction apparatus according to claim 13, further comprising means for variably changing the gain of the signal detected by either said first or second signal detection unit.

15. The information reproduction apparatus according to claim 14, further comprising means for changing the gain of the signal detected by either said first or second signal detection unit, according to the wavelength of a beam from said light source.

16. The information reproduction apparatus according to claim 13, wherein the signal detected by said first signal detection unit is amplified with an AC amplifier.

17. The information reproduction apparatus according to claim 13, wherein the signal detected by said first signal detection unit is amplified with an amplifier configured with compound semiconductor transistors.

18. An information reproduction apparatus comprising:
a light source which emits a beam that irradiates an information recording medium;
first and second signal detection units to detect a signal recorded on said information recording medium from a reflected beam from said information recording medium;
an AC amplifier to amplify the signal detected by said first signal detection unit; and
a DC amplifier to amplify the signal detected by said second signal detection unit,
wherein auto-focusing control and tracking control are performed using the signal amplified by said DC amplifier and the signal amplified by said AC amplifier is decoded.

19. The information reproduction apparatus according to claim 18, further comprising a clipping follow-up correction means which detects peak and bottom voltages of a modulation signal for a long mark with regard to the signal amplified by said AC amplifier and changes a DC level offset voltage for an excess of voltage above the peak or a shortage below the bottom level.
